(19) United States
(12) Patent Application Publication
(10) Pub. No.: US 2023/0373437 A1
(43) Pub. Date: Nov. 23, 2023

(54) ACCESS SYSTEM AND METHOD OF OPERATING AN ACCESS SYSTEM FOR A MOTOR VEHICLE

(71) Applicant: MAGNA CLOSURES INC., Newmarket (CA)

(72) Inventors: Samuel R. BARUCO, Newmarket (CA); James J. FERRI, Newmarket (CA); Ryan BAERG, Newmarket (CA); Peter SERCL, Newmarket (CA); Ryan Herman, Newmarket (CA)

(21) Appl. No.: 18/131,970

(22) Filed: Apr. 7, 2023

Related U.S. Application Data
(63) Continuation-in-part of application No. 18/097,017, filed on Jan. 13, 2023.
(60) Provisional application No. 63/300,331, filed on Jan. 18, 2022.
(60) Provisional application No. 63/337,390, filed on May 2, 2022.

(51) Int. Cl. B60R 25/24; G07C 9/00; B60R 25/30

(52) U.S. Cl. CPC B60R 25/24; G07C 9/00309; B60R 25/305; G07C 2009/00341

(57) ABSTRACT

A user detection system and method a motor vehicle that has a closure panel for facilitating access to the motor vehicle by a user of the motor vehicle are provided. The system includes a hardware token associated with and carried by the user to provide an authorization to access the motor vehicle. The system additionally includes at least two proximity sensors configured to detect the hardware token in proximity to the motor vehicle. The system also includes a controller connected to the at least two proximity sensors and configured to determine a location of the user relative to the motor vehicle using the at least two proximity sensors. The controller grants or rejects access to the motor vehicle via the at least one closure panel based on the authorization and the location of the user relative to the motor vehicle.

### CROSS-REFERENCE TO RELATED APPLICATION

This application is a continuation-in-part of U.S. application Ser. No. 18/097,017 filed Jan. 18, 2023, which claims the benefit of U.S. Provisional Application No. 63/300,331 filed Jan. 18, 2022. This application also claims the benefit of U.S. Provisional Application No. 63/337,390 filed May 2, 2022. The entire disclosures of the above applications are incorporated herein by reference.

### FIELD

The present disclosure relates to an access system for a motor vehicle. More specifically, the present disclosure relates to an access system for detecting a user and controlling a vehicle function based on user proximity to vehicle.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis. In such an arrangement, each door hinge typically includes a door hinge strap connected to the passenger door, a body hinge strap connected to the vehicle body, and a pivot pin arranged to pivotably connect the door hinge strap to the body hinge strap and define a pivot axis. As another example, the closure member can be a hood or frunk lid.

Various functions may be associated with the closure members, such as locking and unlocking, obstacle detection, automatic and/or assisted opening. As a result, the closure members may include a plurality sensors to control the various functions. Nevertheless, even by utilizing the plurality of sensors, difficulty remains in accurately determining an intent of a user to activate or utilize the various functions.

In view of the above, there remains a need to develop improved access systems for vehicles which address and overcome limitations and drawbacks associated with known systems as well as to provide increased convenience and enhanced operational capabilities.

### SUMMARY

This section provides a general summary of the disclosure, and is not a comprehensive disclosure of its full scope or all of its features.

It is an object of the present disclosure to provide a user detection system for a motor vehicle. The motor vehicle has at least one closure panel for facilitating access to the motor vehicle by a user of the motor vehicle. The user detection system includes a hardware token associated with and carried by the user to provide an authorization to access the motor vehicle. The user detection system additionally includes at least two proximity sensors configured to detect the hardware token in proximity to the motor vehicle. A controller is connected to the at least two proximity sensors and is configured to determine a location of the user relative to the motor vehicle using the at least two proximity sensors. The controller grants or rejects access to the motor vehicle via the at least one closure panel based on the authorization and the location of the user relative to the motor vehicle.

In another aspect, the controller is configured to determine at least one of an approach trajectory and a non-identifying biometric information and a non-identifying biomechanical information using the at least two proximity sensors. The controller is also configured to infer an intent of the user to access the motor vehicle based on the at least one of the approach trajectory and the non-identifying biometric information and the non-identifying biomechanical information.

In another aspect, the controller is configured to infer the intent of the user to access the motor vehicle based on the at least one of the approach trajectory corresponding to the user approaching the motor vehicle and correlated to an environment surrounding the motor vehicle.

In another aspect, a plurality of valid access zones are defined around the motor vehicle and the controller is configured to infer the intent of the user to access the motor vehicle based on the user approaching the motor vehicle in one of the plurality of valid access zones.

In another aspect, the controller is configured to read stored access zone information defining the plurality of valid access zones. The controller is also configured to compare the approach trajectory and location of the user to the stored access zone information. The controller grants or rejects access to the motor vehicle via the closure panel based on the authorization and the comparison of the approach trajectory and location of the user to the stored access zone information.

In another aspect, the controller is configured to poll an environment surrounding the motor vehicle for the hardware token registered to the motor vehicle using the at least two proximity sensors. The controller is also configured to decide if the user associated with the hardware token detected meets predetermined authorization requirements for accessing the motor vehicle based on authorization signals received by the at least two proximity sensors from the hardware token. The controller is additionally configured to wake up the user detection system and send and receive location signals from the hardware token using the at least two proximity sensors and determine the at least two distances between the user and each of the at least two sensor positions. In addition, the controller is configured to execute the positioning algorithm and compute the location of the user relative to the motor vehicle using the positioning algorithm. The controller determines at least one of the approach trajectory and the non-identifying biometric information and the non-identifying biomechanical information using the at least two proximity sensor. The controller then analyzes the at least one of the approach trajectory and the location of the user and execute analysis of the non-identifying biometric information and the non-identifying biomechanical information. The controller verifies that the user is approaching the motor vehicle within one of the plurality of valid access zones surrounding the motor vehicle. The controller is also configured to grant or reject access to the motor vehicle via the closure panel in response to the hardware token detected meeting the predetermined authorization requirements and the analysis of the at least one of the approach trajectory and the location of the user, the non-identifying biometric information, and the non-identifying biomechanical information.

In another aspect, the hardware token includes at least one of a key fob and a mobile phone located with the user.

It is another object of the present disclosure to provide a method of operating a user detection system for a motor vehicle. The motor vehicle has at least one closure panel for facilitating access to the motor vehicle by a user of the motor vehicle. The method includes the step of determining a location of the user relative to the motor vehicle using at least two proximity sensors configured to detect the hardware token in proximity to the motor vehicle. The method also includes the step of granting or rejecting access to the motor vehicle via the at least one closure panel based on the authorization provided by a hardware token associated with and carried by the user and the location of the user relative to the motor vehicle.

In another aspect, the at least two proximity sensors are disposed at at least two sensor positions on the motor vehicle. The method further includes the step of determining at least two distances between the user and each of the at least two sensor positions. The method continues by computing the location of the user relative to the motor vehicle using a positioning algorithm relative to the at least two sensor positions.

In another aspect, the at least two proximity sensors includes a first sensor disposed at a first sensor position on the motor vehicle and a second sensor disposed at a second sensor position on the motor vehicle. The first sensor position is a sensor spacing distance from the second sensor position. The method further includes the step of determining a first distance between the user and the first sensor position and a second distance between the user and the second sensor position. Next, defining a first circle with a first radius of the first distance and a second circle with a second radius of the second distance. The first circle and the second circle intersect at two intersection points. The method also includes the step of determining the location of the user relative to the motor vehicle based on the two intersection points.

In another aspect, the method further includes the step of determining at least one of an approach trajectory and a non-identifying biometric information and a non-identifying biomechanical information using the at least two proximity sensors. The method additionally includes the step of inferring an intent of the user to access the motor vehicle based on the at least one of the approach trajectory and the non-identifying biometric information and the non-identifying biomechanical information.

In another aspect, the step of inferring the intent of the user to access the motor vehicle based on the at least one of the approach trajectory and the non-identifying biometric information and the non-identifying biomechanical information includes inferring the intent of the user to access the motor vehicle based on the at least one of the approach trajectory corresponding to the user approaching the motor vehicle and correlated to an environment surrounding the motor vehicle.

In another aspect, a plurality of valid access zones are defined around the motor vehicle and wherein the step of inferring the intent of the user to access the motor vehicle based on the at least one of the approach trajectory and the non-identifying biometric information and the non-identifying biomechanical information includes inferring the intent of the user to access the motor vehicle based on the user approaching the motor vehicle in one of the plurality of valid access zones.

In another aspect, the method further includes the step of reading stored access zone information defining the plurality of valid access zones. The method proceeds by comparing the approach trajectory and location of the user to the stored access zone information. The method continues with the step of granting or rejecting access to the motor vehicle via the closure panel based on the authorization and the comparison of the approach trajectory and location of the user to the stored access zone information.

In another aspect, the method further includes the step of polling an environment surrounding the motor vehicle for the hardware token registered to the motor vehicle using the at least two proximity sensors. The method proceeds with the step of deciding if the user associated with the hardware token detected meets predetermined authorization requirements for accessing the motor vehicle based on authorization signals received by the at least two proximity sensors from the hardware token. Next, waking up the user detection system and sending and receiving location signals from the hardware token using the at least two proximity sensors and determining the at least two distances between the user and each of the at least two sensor positions The method continues by executing the positioning algorithm and compute the location of the user relative to the motor vehicle using the positioning algorithm. In addition, the method includes the step of determining at least one of the approach trajectory and the non-identifying biometric information and the non-identifying biomechanical information using the at least two proximity sensors. The next step of the method is analyzing the at least one of the approach trajectory and the location of the user and executing analysis of the non-identifying biometric information and the non-identifying biomechanical information. The method additionally includes verifying that the user is approaching the motor vehicle within one of the plurality of valid access zones surrounding the motor vehicle. The method also includes the step of granting or rejecting access to the motor vehicle via the closure panel in response to the hardware token detected meeting the predetermined authorization requirements and the analysis of the at least one of the approach trajectory and the location of the user the non-identifying biometric information and the non-identifying biomechanical information.

In another aspect, the hardware token includes at least one of a key fob and a mobile phone located with the user.

It is a further object of the present disclosure to provide a user detection system for a motor vehicle. The motor vehicle has at least one closure panel for facilitating access to the motor vehicle by a user of the motor vehicle. The user detection system includes at least one proximity sensor configured to sense the user in one of a plurality of valid access zones defined around the motor vehicle. The user detection system also includes at least one non-contact obstacle detection sensor configured to detect at least one obstacle. A controller is connected to the at least one proximity sensor and the at least one non-contact obstacle detection sensor and is in communication with an access system of the motor vehicle associated with the at least one closure panel. The controller is configured to determine a location of the user relative to the motor vehicle and whether the user is approaching the motor vehicle within one of the plurality of valid access zones using the at least one proximity sensor. The controller is also configured to detect the at least one obstacle in proximity to the motor vehicle using the at least one non-contact obstacle detection sensor and modify a functionality associated with the plurality of valid access zones to a modified access functionality based on detection of the at least one obstacle in proximity to the motor vehicle. The controller is additionally configured to control the access system based on the location of the user relative to the motor vehicle and whether the user is within one of the plurality of valid access zones and the modified access functionality.

In another aspect, the at least one proximity sensor includes an optical sensor configured to detect facial landmarks of a face of the user corresponding to an intent of the user to access the motor vehicle and an ultra wideband sensor configured to sense the user in one of the plurality of valid access zones. The controller is configured to determine whether the user is within one of the plurality of valid access zones using the ultra wideband sensor. The controller is also configured to infer the intent of the user based on the facial landmarks of the face of the user and whether the user is within one of the plurality of valid access zones and control the access system accordingly.

In another aspect, the at least one closure panel includes a door, and the access system includes a power closure member actuation system configured to move the door. The controller is configured to detect the user approaching the motor vehicle. The controller is also configured to determine whether the user is forward of a B-pillar of the motor vehicle and determine whether a path of the door is clear in response to determining the user is forward of the B-pillar of the motor vehicle. The controller opens the door to a small predetermined angle to allow the user to walk around the door using the power closure member actuation system in response to determining the path of the door is clear. The controller is additionally configured to provide a follow me function of the door as user moves past the B-pillar of the motor vehicle using the power closure member actuation system. The controller presents the door for a power assist mode operation by the user in response to determining the path of the door is not clear. The controller is further configured to determine whether the path of the door is clear in response to determining the user is not forward of the B-pillar of the motor vehicle. The controller is also configured to open the door to a fully open position using the power closure member actuation system in response to determining the path of the door is clear. The controller opens the door to an angle controlled by the at least one non-contact obstacle detection sensor using the power closure member actuation system in response to determining the path of the door is not clear.

It is yet another object of the present disclosure to provide a method of operating a user detection system for a motor vehicle. The motor vehicle has at least one closure panel for facilitating access to the motor vehicle by a user of the motor vehicle. The method includes the step of determining a location of the user relative to the motor vehicle and whether the user is approaching the motor vehicle within one of the plurality of valid access zones using at least one proximity sensor configured to sense the user in one of a plurality of valid access zones defined around the motor vehicle. The method continues with the step of detecting at least one obstacle in proximity to the motor vehicle using at least one non-contact obstacle detection sensor configured to detect the at least one obstacle and modifying a functionality associated with the plurality of valid access zones to a modified access functionality based on detection of the at least one obstacle in proximity to the motor vehicle. The method also includes the step of controlling an access system of the motor vehicle associated with the at least one closure panel based on the location of the user relative to the motor vehicle and whether the user is within one of the plurality of valid access zones and the modified access functionality.

In another aspect, the at least one closure panel includes a plurality of closure panels each defining one of a plurality of closure boundaries and the plurality of valid access zones defined around the motor vehicle extend and are defined at a plurality of predetermined angles from the plurality of closure boundaries.

In another aspect, the at least one closure panel includes at least one door and a decklid and a hood. The plurality of valid access zones defined around the motor vehicle include a valid hood access zone adjacent the hood of the motor vehicle and a valid front right access zone adjacent the at least one door on a right side of the motor vehicle and a valid trunk access zone adjacent the decklid of the motor vehicle and a valid front left access zone adjacent the at least one door on a left side of the motor vehicle. The plurality of valid access zones are separated from one another by each of a plurality of invalid access zones.

In another aspect, the at least one proximity sensor includes an optical sensor configured to detect facial landmarks of a face of the user corresponding to an intent of the user to access the motor vehicle and an ultra wideband sensor configured to sense the user in one of the plurality of valid access zones. The method further includes the step of determining whether the user is within one of the plurality of valid access zones using the ultra wideband sensor. The method also includes the step of inferring the intent of the user based on the facial landmarks of the face of the user and whether the user is within one of the plurality of valid access zones and control the access system accordingly.

In another aspect, the at least one closure panel includes a door and the access system includes a power closure member actuation system configured to move the door. The method further includes the step of detecting the user approaching the motor vehicle. Next, determining whether the user is forward of a B-pillar of the motor vehicle. The method continues by determining whether a path of the door is clear in response to determining the user is forward of the B-pillar of the motor vehicle. The next step of the method is opening door to a small predetermined angle to allow the user to walk around the door using the power closure member actuation system in response to determining the path of the door is clear. The method proceeds with the step of providing a follow me function of the door as user moves past the B-pillar of the motor vehicle using the power closure member actuation system. In addition, the method includes the step of presenting the door for a power assist mode operation by the user in response to determining the path of the door is not clear. Next, determining whether the path of the door is clear in response to determining the user is not forward of the B-pillar of the motor vehicle. The method also includes the step of opening door to a fully open position using the power closure member actuation system in response to determining the path of the door is clear. The method additionally includes the step of opening door to an angle controlled by the at least one non-contact obstacle detection sensor using the power closure member actuation system in response to determining the path of the door is not clear.

It is yet a further object of the present disclosure to provide a method of facilitating access to a motor vehicle by a user of the motor vehicle having at least one closure panel for an entry of the motor vehicle. The method includes the step of using at least one proximity sensor and sensing the user around the motor vehicle. In addition, the method includes the step of determining at least one of a location of the user relative to the motor vehicle and whether the user is approaching the motor vehicle. Next, determining if moving the closure panel to an opened position using an access system of the motor vehicle associated with the at least one closure panel obstructs an approach of the user towards the entry. The method also includes the step of controlling the access system based on the location of the user relative to the motor vehicle to prevent the closure panel from obstructing the approach of the user towards the entry.

In another aspect, the method also includes the step of determining if the user has moved from a first location where the closure panel in the opened position would obstruct the approach of the user towards the entry to a second location where the approach of the user towards the entry is not obstructed by the closure panel in the opened position.

In another aspect, the method also includes the step of controlling the access system to move the closure panel to the opened position after determining the user has moved to an unobstructed location where the approach of the user towards the entry is not obstructed by the closure panel in the opened position.

In another aspect, the method also includes the step of detecting at least one obstacle in proximity to the motor vehicle using at least one non-contact obstacle detection sensor configured to detect the at least one obstacle and modifying a functionality associated controlling the access system.

In accordance with a further aspect, there is provided a user detection system for a motor vehicle having at least one closure panel for facilitating access to the motor vehicle by a user of the motor vehicle, the user detection system comprising a proximity detection system configured to detect a user in proximity to the motor vehicle and a controller connected to the proximity detection system and configured to determine a location of the user relative to the motor vehicle using the at least two proximity sensors, and grant access to the motor vehicle via the at least one closure panel based on the location of the user relative to the motor vehicle in a valid access zone and deny access to the motor vehicle via the at least one closure panel based on the location of the user relative to the motor vehicle in an invalid access zone.

In accordance with a further aspect, there is provided a method of controlling access to a motor vehicle having at least one closure panel for facilitating access to the motor vehicle by a user of the motor vehicle, the method comprising determining a location of the user relative to the motor vehicle using a proximity detection sensor system; granting access to the motor vehicle via the at least one closure panel based on the location of the user relative to the motor vehicle detected in a valid access zone; and denying access to the motor vehicle via the at least one closure panel based on the location of the user relative to the motor vehicle detected in an invalid access zone.

In accordance with a further aspect, there is provided a user detection system for a motor vehicle having at least one closure panel for facilitating access to the motor vehicle by a user of the motor vehicle, the user detection system comprising a proximity detection system configured to detect a user in proximity to the motor vehicle and a controller connected to the proximity detection system and configured to determine a location of the user relative to the motor vehicle using the at least two proximity sensors, and grant access to the motor vehicle via the at least one closure panel based on the location of the user relative to the motor vehicle in a valid access zone and deny access to the motor vehicle via the at least one closure panel based on the location of the user relative to the motor vehicle in an invalid access zone; wherein the controller is further configured to alter the valid access zone and invalid access zone.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of an example motor vehicle equipped with closure members movable relative to a vehicle body, according to aspects of the disclosure;

FIG. 2 is a top view of the vehicle of FIG. 1 illustrating a plurality of zones, according to aspects of the disclosure;

FIG. 3 is a block diagram illustrating a system for controlling a vehicle function of the motor vehicle of FIG. 1, according to aspects of the disclosure;

FIG. 4 is another block diagram illustrating the system, according to aspects of the disclosure;

FIG. 5 illustrates a polling rate of at least one proximity sensor increasing, according to aspects of the disclosure;

FIG. 6 illustrates the polling rate of the at least one proximity sensor decreasing, according to aspects of the disclosure;

FIGS. 7-14 illustrate steps of a method for controlling a vehicle function of the vehicle, according to aspects of the disclosure;

FIG. 15 is yet another block diagram illustrating the system, according to aspects of the disclosure;

FIG. 16 is a further block diagram illustrating the system, according to aspects of the disclosure;

FIGS. 17-19 illustrate steps of another method for controlling the vehicle function of the vehicle, according to aspects of the disclosure;

FIG. 20 is another block diagram illustrating another system for controlling a vehicle function of the vehicle of FIG. 1, according to aspects of the disclosure;

FIG. 21 illustrates an example of a predetermined authentication distance, a predetermined sensing distance, and a predetermined access distance relative to the motor vehicle, according to aspects of the disclosure;

FIG. 22 shows a table of example approach characteristics, their respective individual confidence levels, and the sum of individual confidence levels, according to aspects of the disclosure;

FIG. 23 is a table illustrating example actions based on the sum of individual confidence levels, according to aspects of the disclosure;

FIG. 24 shows example actions or functions that may be completed at each of the predetermined authentication distance, the predetermined sensing distance, and the predetermined access distance, according to aspects of the disclosure;

FIG. 25 shows a table including a plurality of power door (PD) control input sources, interface signals to the PD control, signal content, PD control response, and when applicable to the first functional level, and the second functional level, and the third functional level, according to aspects of the disclosure;

FIG. 26 shows more details about the first functional level including the types of sensors used, according to aspects of the disclosure;

FIG. 27 shows more details about the first functional level including the types of sensors used, according to aspects of the disclosure;

FIG. 28 shows more details about the first functional level including the types of sensors used, according to aspects of the disclosure;

FIG. 29 illustrates steps of a method for controlling a system of a motor vehicle for facilitating access to the motor vehicle by a user of the motor vehicle, according to aspects of the disclosure;

FIGS. 30 to 34 are illustrative examples of users moving about the vehicle detected by the one or more sensors of the systems and methods described herein;

FIG. 35 is a block diagram of a user detection system for the motor vehicle, according to aspects of the disclosure;

FIG. 36 shows an example positioning algorithm used by the user detection system, according to aspects of the disclosure;

FIG. 37 shows an example of a plurality of valid access zones around the vehicle, according to aspects of the disclosure;

FIG. 38 shows examples of different approach paths to the vehicle due to obstacles, according to aspects of the disclosure;

FIG. 39 illustrates a potential vehicle access truth table for the system using specific sensors to determine user intent and trigger access systems, according to aspects of the disclosure;

FIGS. 40-42 illustrate steps of methods of operating a user detection system, according to aspects of the disclosure;

FIG. 43 shows top views of the motor vehicle pictorially illustrating specific scenarios corresponding to one or more steps of the method shown in FIG. 42, according to aspects of the disclosure; and

FIGS. 44A to 44C show various controlled configurations of access and rejection detection zones adjacent the vehicle, according to aspects of the disclosure.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

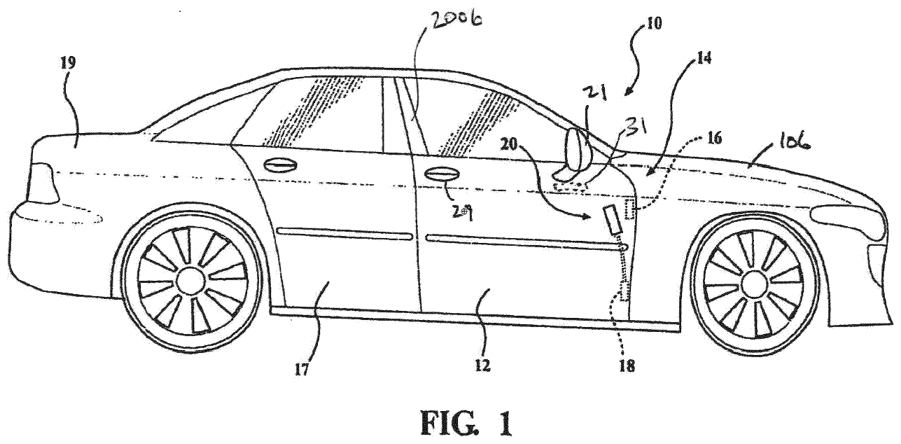

Referring initially to FIG. 1, an example motor vehicle 10 is shown to include a closure member (e.g., a first passenger door 12) pivotally mounted to a vehicle body 14 via an upper door hinge 16 and a lower door hinge 18 which are shown in phantom lines. A power closure member actuation system 20 is integrated into the pivotal connection between first passenger door 12 and a vehicle body 14. In accordance with a preferred configuration, power closure member actuation system 20 generally includes a power-operated actuator mechanism or actuator 22 secured within an internal cavity of passenger door 12, and a rotary drive mechanism that is driven by the power-operated actuator mechanism 22 and is drivingly coupled to a hinge component associated with lower door hinge 18. Driven rotation of the rotary drive mechanism causes controlled pivotal movement of passenger door 12 relative to vehicle body 14. In accordance with this preferred configuration, the power-operated actuator mechanism 22 is rigidly coupled in close proximity to a door-mounted hinge component of upper door hinge 16 while the rotary drive mechanism is coupled to a vehicle-mounted hinge component of lower door hinge 18. However, those skilled in the art will recognize that alternative packaging configurations for power closure member actuation system 20 are available to accommodate available packaging space. One such alternative packaging configuration may include mounting the power-operated actuator mechanism to vehicle body 14 and drivingly interconnecting the rotary drive mechanism to a door-mounted hinge component associated with one of upper door hinge 16 and lower door hinge 18. The door 12 also includes a side mirror 21 of the vehicle 10 including an LED light 160 and mirror backup power 21a. In addition, the door 12 includes an outside handle 29 including a capacitive switch 29a and an LED light 160 and an inside handle 31 including a mechanical switch 31a.

Each of upper door hinge 16 and lower door hinge 18 include a door-mounting hinge component and a body-mounted hinge component that are pivotably interconnected by a hinge pin or post. The door-mounted hinge component is hereinafter referred to a door hinge strap while the body-mounted hinge component is hereinafter referred to as a body hinge strap. While front passenger door 12 is shown, those skilled in the art will recognize that the motor vehicle 10 may include other closure members (e.g., door or liftgate) of vehicle 10 such as rear passenger doors 17, decklid 19, and a hood 106 or frunk lid.

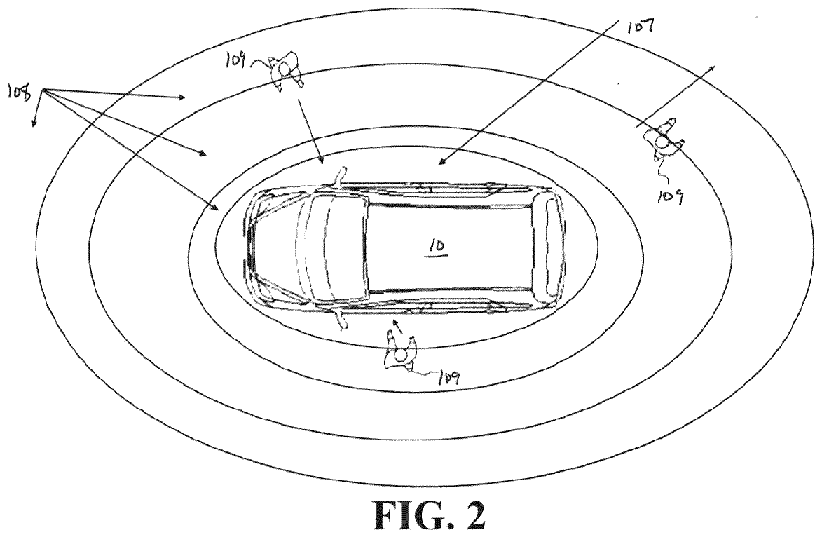

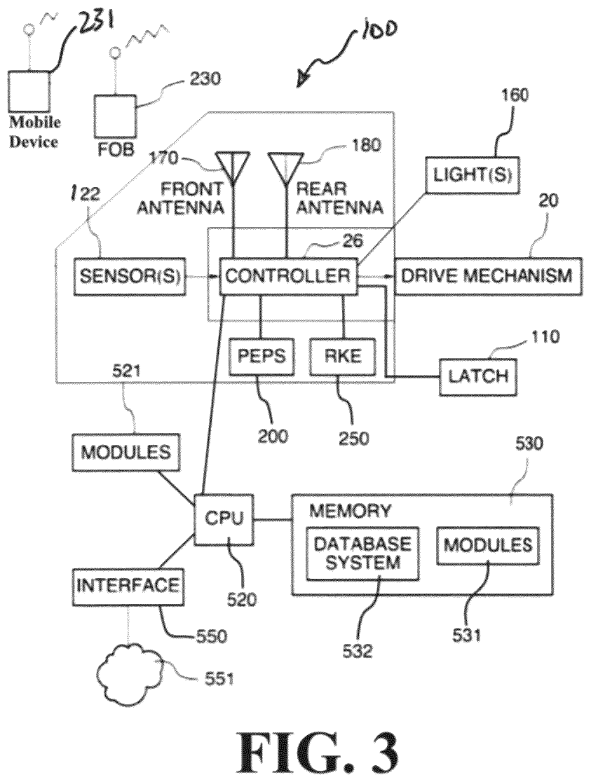

FIG. 2 is a top view of the vehicle 10 of FIG. 1 illustrating a plurality of zones 107, 108. In more detail, one or more proximity sensors 122 (FIG. 3) (discussed in more detail below) is configured to detect a user 109 in one of the plurality of zones 107, 108. As shown, the plurality of zones 107, 108 includes at least one short range proximity zone 107 adjacent the vehicle 10 and a plurality of medium or long range proximity zones 108 disposed increasing further away from the vehicle 10 than the least one short range proximity zone 107. The plurality of zones 107, 108 can be discrete or continuous.

FIG. 3 is a block diagram illustrating a system 100 for controlling a vehicle function of the vehicle 10 of FIG. 1. The system 100 includes the one or more proximity sensors 122 and a controller (or electronic control unit (“ECU”)) 26. Each sensor 122 may be positioned at various location in the vehicle 10 to cover an area or volume around the vehicle 10. The sensors 122 may be electrically coupled to an optional wire harness (not shown) adapted to plug into the controller 26. The controller 26 controls the latch 110 and drive mechanism 20 to open the door 12 in the event it receives an appropriate electrical signal from one or more of the sensors 122 and other elements of the system 10. Each sensor 122 may have an associated proximity range within which it may sense an object (e.g., a user 109, the user's foot, etc.) and the distance to from the vehicle 10 to the object. The system also includes at least one light 160 also controlled by the controller 26.

The controller 26 includes a processor or central processing unit (“CPU”) 520, memory 530, and an interface device 550. The memory 530 may include a variety of storage devices including internal memory and external mass storage typically arranged in a hierarchy of storage as understood by those skilled in the art. For example, the memory 530 may include databases, random access memory (“RAM”), read-only memory (“ROM”), flash memory, and/or disk devices. The interface device 550 may include one or more network connections. The controller 26 may be adapted for communicating with other data processing systems (e.g., similar to controller 26) over a network 551 via the interface device 550. For example, the interface device 550 may include an interface to a network 551 such as a local area network (“LAN”), etc. As such, the interface 550 may include suitable transmitters, receivers, etc. Thus, the controller 26 may be linked to other data processing systems by the network 551. The CPU 520 may include or be operatively coupled to dedicated coprocessors, memory devices, or other hardware modules 521. The CPU 520 is operatively coupled to the memory 530 which stores an operating system (e.g., 531) for general management of the controller 26. The controller 26 may include a data store or database system 532 for storing data and programming information. The database system 532 may include a database management system (e.g., 532) and a database (e.g., 532) and may be stored in the memory 530 of the controller 26. In general, the controller 26 has stored therein data representing sequences of instructions which when executed cause the method described herein to be performed. Of course, the controller 26 may contain additional software and hardware a description of which is not necessary for understanding the invention.

Thus, the controller 26 includes computer executable programmed instructions for directing the controller 26 to implement the embodiments of the present disclosure. The programmed instructions may be embodied in one or more hardware modules 521 or software modules 531 resident in the memory 530 of the controller 26 or elsewhere (e.g., 520). Alternatively, the programmed instructions may be embodied on a computer readable medium or product (e.g., a memory stick, etc.) which may be used for transporting the programmed instructions to the memory 530 of the controller 26. Alternatively, the programmed instructions may be embedded in a computer-readable signal or signal-bearing medium or product that is uploaded to a network 551 by a vendor or supplier of the programmed instructions, and this signal or signal-bearing medium may be downloaded through an interface (e.g., 550) to the controller 26 from the network 551 by end users or potential buyers.

The latch 110 and drive mechanism 20 are controlled in part by the system 100. It will be appreciated by those skilled in the art that the system 100 may be applied to any motorized or automated closure panel structure that moves between an open position and a closed position. For example, a non-exhaustive list of closure panels includes window panes, sliding doors, tailgates, sunroofs and the like. For applications such as window panes or sun roofs, the sensor 122 may be mounted on the body 14 of the vehicle 10, and for applications such as powered liftgates and sliding doors the sensor 122 may be mounted on or within the bumper.

The sensors 122 may come in different forms, including non-contact proximity sensors which are typically based on capacitance changes. These are referred to as capacitive sensors in the following.

Capacitive sensors typically include a conductive strip, including, for example, a metal strip or wire. The conductive strip may be embedded in a non-conductive material, such as a non-conductive plastic or rubber strip, which is routed along and adjacent to the periphery of the bumper or wheel-well. The metal strip or wire and the chassis of the vehicle 10 may collectively form the two plates of a sensing capacitor. Alternatively, the sensor 122 may incorporate two discrete electrodes separately, or embedded together within the non-conductive material. An example of such a sensor 122 is described below. An obstacle placed near these two electrodes changes the dielectric constant and thus varies the amount of charge stored by the sensing capacitor over a given period of time. The charge stored by the sensing capacitor is transferred to a reference capacitor in order to detect the presence of the obstacle. The capacitive sensor is typically driven by a pulsed signal from a controller 26. Example sensors and possible mountings to a fascia are described in U.S. Patent Application No. 61/791,472 by Pribisic, et al., filed Mar. 15, 2013, the entire content of which is hereby incorporated by reference, and in U.S. Patent Application No. 61/791,322 by Pribisic et al., filed Mar. 15, 2013, the entire content of which is hereby incorporated by reference. Example driving of a sensor, particularly to minimize electrical noise, is described in U.S. Patent Application No. 61/791,779 by Pribisic et al., filed Mar. 15, 2013, the entire content of which is hereby incorporated by reference. It is to be recognized that these are only example capacitive sensors 122 and other capacitive proximity sensors, or non-capacitive proximity sensors, such as, for example, optical sensors, ultrasonic, infra-red, lidar, radar, acoustic sensors, or radio frequency (fob based) sensors could be used.

The controller 26 may be a separate electronic control unit (“ECU”) or may be coupled to or incorporated in the vehicle's main or central ECU system (e.g., a vehicle ECU, a body control module 27 (“BCM”), etc.). The controller 26 may be coupled to an authentication system, such as a passive entry passive start (“PEPS”) type system 200, a remote keyless entry (“RKE”) system 250, a front end antenna 170 associated with at least one of the PEPS system 200 and the RKE system 250, and a rear end antenna 180 also associated with at least one of the PEPS system 200 and the RKE system 250. For reference, both the PEPS system 200 and the RKE system 250 work with an electronic keyfob or fob 230 and/or mobile phone 231 that is located with the user 109. The PEPS and/or RKE systems 200, 250 receive signals from the fob 230 through one or more of the front and rear antennae 170, 180 to initiate an operation such as, for example, controlling the door 12 to open or close, etc. In general, a PEPS system 200 does not require the user 109 to push a button on the fob 230 and/or mobile phone 231 to initiate an operation. In contrast, a RKE system 250 does require the user 109 to push a button on the fob 230 and/or mobile phone 231 to initiate an operation. According to one example embodiment, the PEPS system 200 is a stand-alone, unmodified system coupled to the antennae 170, 180 and the controller 26 intercepts required signals from the PEPS system 200 to implement the method of the example embodiment.

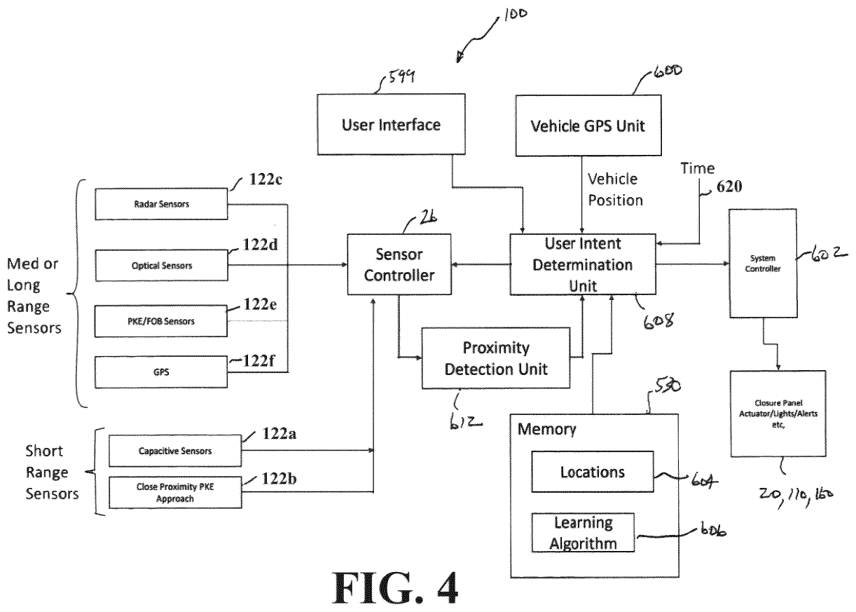

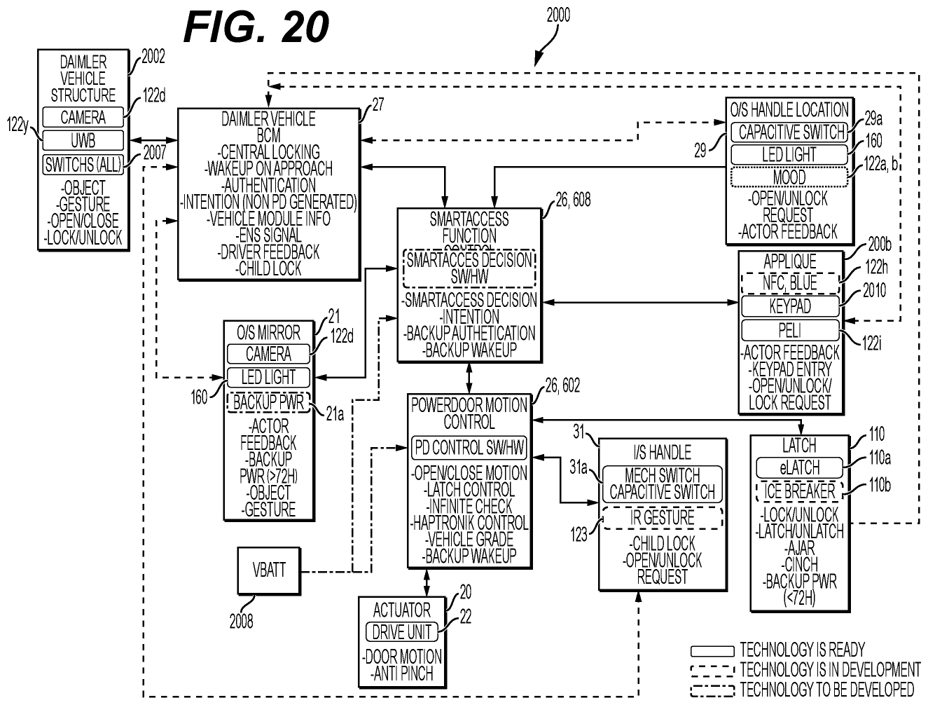

FIG. 4 is another block diagram illustrating the system 100. The system 100 includes the at least one proximity sensor 122 for sensing the position of the user 109 relative to the vehicle 10. The system 100 also includes an activation sensor 123 (FIG. 20) for sensing an activation gesture of the user 109. The system 100 additionally includes a vehicle system or access system 20, 110, 160 for controlling the vehicle function. A controller 26 of the system 100 is in communication with the at least one proximity sensor 122, the activation sensor 123 (e.g., Infrared), and the vehicle system 20, 110, 160. The controller 26 is configured to modify operation of the activation sensor 123 based on the position of the user 109 relative to the vehicle 10 detected using the proximity sensor 122, and to control the vehicle system 20, 110, 160.

The at least one proximity sensor 122 includes at least one short range proximity sensor 122a, 122b for sensing the position of the user 109 relative to the vehicle 10 in the at least one short range proximity zone 107 and at least one medium or long range proximity sensor 122c, 122d, 122e, 122f for sensing the position of the user 109 relative to the vehicle 10 in the plurality of medium or long range proximity zones 108. The at least one short range proximity sensor 122a, 122b is selected from a group comprising capacitive sensors 122a and close proximity PKE (passive keyless entry) approach sensors 122b. The at least one medium or long range proximity sensor 122c, 122d, 122e, 122f is selected from a group consisting of radar sensors 122c, optical sensors 122d, PKE/FOB sensors 122e, and GPS sensors 122f.

Continuing to refer to FIG. 4, the system 100 also includes a user interface 599 for interfacing with the user 109. In addition, the system 100 includes a vehicle global positioning system unit 600 for sensing a vehicle position of the vehicle 10. The system 100 additionally includes at least one system controller 602 coupled to the vehicle system 20, 110, 160. As discussed above, the system 100 can also include the memory 530. The memory 530 includes a plurality of locations 604 and a learning algorithm 606. The system 100 includes a user intent determination unit 608 for determining a user intent and coupled to a time input 610 and the controller 26 and the user interface 599 and the vehicle global positioning system unit 600 and the at least one system controller 602 and the memory 530. The system 100 additionally includes a proximity detection unit 612 for determining the position of the user 109 relative to the vehicle 10 and coupled to the controller 26 and the user intent determination unit 608.

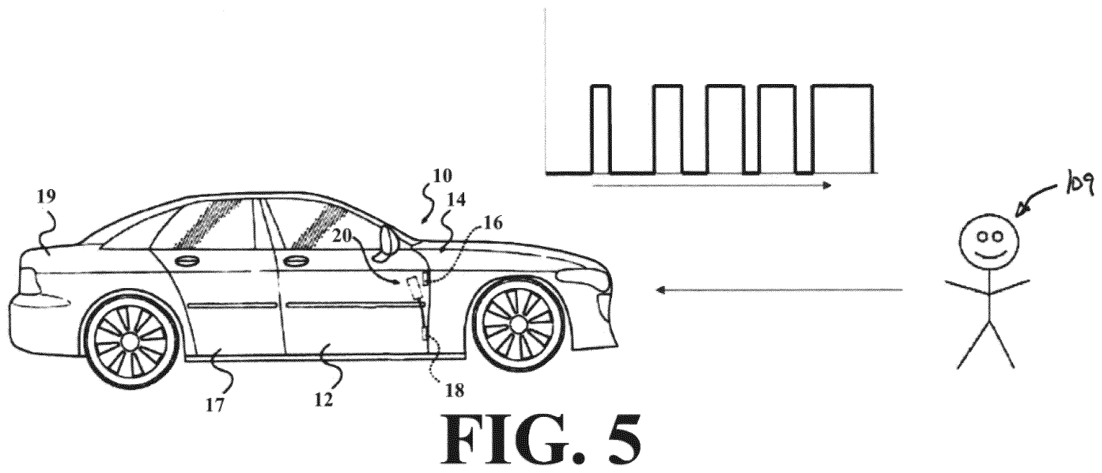

FIG. 5 illustrates a polling rate of at least one proximity sensor 122 increasing. According to an aspect, the controller 26 is further configured to increase a polling rate of the at least one proximity sensor 122 at the vehicle 10 in response to the user 109 being detected approaching the vehicle 10. In more detail, the plurality of zones 107, 108 includes an activation zone (e.g., the at least one short range proximity zone 107) immediately adjacent the vehicle 10 and a plurality of wakeup zones (e.g., the plurality of medium or long range proximity zones 108) further from the vehicle 10 than the activation zone. Thus, the controller 26 is further configured to monitor the at least one medium or long range proximity sensor 122c, 122d, 122e, 122f using a first duty cycle. The controller 26 is also configured to determine whether the user 109 is detected in one of a plurality of wakeup zones. The controller 26 determines whether the user 109 is moving in response to the user 109 being detected in one of the plurality of wakeup zones. The controller 26 is additionally configured to return to monitor the at least one medium or long range proximity sensor 122c, 122d, 122e, 122f using the first duty cycle in response to the user 109 not being detected in one of the plurality of wakeup zones. The controller 26 operates sensor polling of the at least one proximity sensor 122 using an increasing duty cycle higher than the first duty cycle as the user 109 is detected in the one of the plurality of wakeup zones closer to the vehicle 10 in response to determining the user 109 is moving. The controller 26 is additionally configured to return to monitor the at least one medium or long range proximity sensor 122c, 122d, 122e, 122f using the first duty cycle in response to determining the user 109 is not moving. In addition, the controller 26 is configured to determine whether the user 109 is detected in an activation zone. The controller 26 is configured to operate the at least one short range proximity sensor 122a, 122b to confirm activation intent of the user 109 in response to the user 109 being detected in the activation zone. The controller 26 returns to determine whether the user 109 is detected in one of the plurality of wakeup zones in response to the user 109 being detected in the activation zone.

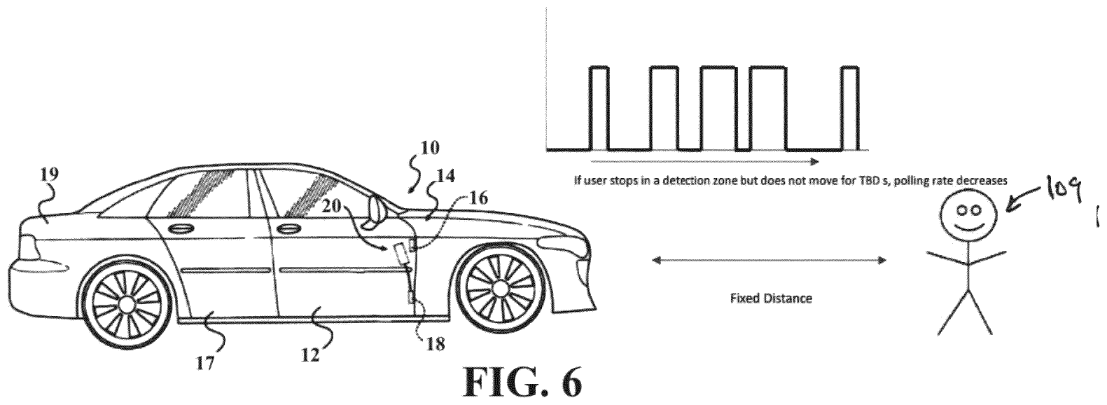

According to another aspect, the controller 26 is further configured to operate the at least one proximity sensor 122 at a first polling rate. The controller 26 is also configured to determine whether the user 109 is detected in one of a plurality of wakeup zones. The controller 26 returns to operate the at least one proximity sensor 122 at the first polling rate in response to the user 109 not being detected in one of the plurality of wakeup zones. The controller 26 is configured to track the user 109 in the plurality of wakeup zones in response to user 109 being detected in one of the plurality of wakeup zones. In addition, the controller 26 is configured to increase a polling rate of the at least one proximity sensor 122 beyond the first polling rate based on tracking the user 109 moving closer to the vehicle 10. The controller 26 decreases the polling rate of the at least one proximity sensor 122 to be less than the first polling rate based on tracking the user 109 moving away from the vehicle 10. FIG. 6 illustrates the polling rate of the at least one proximity sensor 122 decreasing. According to an additional aspect, the controller 26 is further configured to decrease a polling rate of the at least one proximity sensor 122 in response to the user 109 stopping movement relative to the vehicle 10 for a predetermined stopping time (arrow 598 indicates a fixed distance between the user 109 and the vehicle 10).

As discussed above, the system 100 can include the user interface 599. So, according to yet another aspect, the controller 26 is further configured to determine a user input of a preferred polling rate using the user interface 599. The controller 26 then sets a polling rate of the at least one proximity sensor 122 based on the user input of the preferred polling rate.

As mentioned above, the system 100 can include the GPS sensors 122f and the vehicle global positioning system unit 600 for determining a geographical position, also referred to as a geo-location or geo-position, of the vehicle 10 and the controller 26 is further adapted to determine the activation intent of the user to access the vehicle based on the geo-location. So, according to yet another aspect, the controller 26 is further configured to determine the vehicle position of the vehicle 10 using at least one of the GPS sensors 122f and the vehicle global positioning system unit 600. The controller 26 is configured to set a polling rate of the at least one proximity sensor 122 based on the vehicle position of the vehicle 10. The controller 26 then operates the at least one proximity sensor 122 using the polling rate set. According to a further aspect, the controller 26 is configured to determine the vehicle position of the vehicle 10 using at least one of the GPS sensors 122f and the vehicle global positioning system unit 600. The controller 26 is also configured to disable the at least one medium or long range proximity sensor 122c, 122d, 122e, 122f if the vehicle position correlates to high traffic next to the vehicle 10. The controller 26 is additionally configured to poll the at least one short range proximity sensor 122a, 122b. According to another aspect, the controller 26 is further configured to determine the vehicle position of the vehicle 10 using at least one of the GPS sensors 122f and the vehicle global positioning system unit 600. The controller 26 is also configured to lookup a prestored polling rate based on the vehicle position. The controller 26 operates the at least one proximity sensor 122 using the prestored polling rate. GPS sensors 122f and the vehicle global positioning system unit 600 for determining a geographical position are examples of a sensor system configured to provide information or data about the state of the vehicle to the controller 26. Such geo-position data may be procured directly from on-board vehicle sensors or from a communication system connected to external geolocation positioning infrastructure.

According to another aspect, the controller 26 is further configured to receive environment data in a learning mode. The controller 26 is also configured to monitor proximity activity around the vehicle 10 in the environment in the learning mode. The controller 26 sets a polling rate of the at least one proximity sensor 122 based on the proximity activity monitored around the vehicle 10 in the learning mode. The controller 26 is additionally configured to receive the environment data in an applied learning mode. The controller 26 is configured to detect a recurrence of the environment data in the applied learning mode. The controller 26 uses the polling rate of the at least one proximity sensor 122 set based on the proximity activity monitored around the vehicle 10 in the applied learning mode.

Referring back to FIG. 3, the mobile phone 231 and the keyfob 230 are in communication with the controller 26. So, the controller 26 is further configured to determine the vehicle position of the vehicle 10 using at least one of the GPS sensors 122f and the vehicle global positioning system unit 600 and whether the vehicle 10 is paired to at least one of the mobile phone 231 and the key fob 230. In response to determining the vehicle position is a home position, the controller 26 is configured to disable proximity tracking the at least one proximity sensor 122 and revert to a traditional PKE interface with a reduced sensing distance. Also in response to determining the vehicle position is a home position, the controller 26 is also configured to increase a polling rate of the at least one proximity sensor 122 around learned interaction times to anticipate arrival of the at least one of the mobile phone 231 and the key fob 230 for wakeup. Furthermore in response to determining the vehicle position is a home position, the controller 26 is configured to allow remote wakeup.

In response to determining the vehicle position is a favorite location position, the controller 26 is configured to increase the polling rate of the at least one proximity sensor 122 based on one of the at least one of the mobile phone 231 and the key fob 230 distance from the vehicle 10 increasing and around learned interaction times to anticipate arrival of the at least one of the mobile phone 231 and the key fob 230 for wakeup.

In response to determining the vehicle position is not the home position, increase the polling rate of the at least one proximity sensor 122 as the at least one of the mobile phone 231 and the key fob 230 distance from the vehicle 10 increasing. Also in response to determining the vehicle position is not the home position, the controller 26 is configured to further increasing the polling rate of the at least one proximity sensor 122 if the at least one of the mobile phone 231 and the key fob 230 is not mobile for a predetermined immobile time.

According to another aspect, the system 100 includes an activation sensor 123 for sensing an activation gesture of the user 109. Again, the system 100 also includes a vehicle system 20, 110, 160 for controlling the vehicle function. The system 100 additionally includes a controller 26 in communication with the activation sensor 123 and the vehicle system 20, 110, 160. The controller 26 is configured to modify the operation of the activation sensor 123 based on receiving a signal indicative of the state of the vehicle 10, and to control the vehicle system 20, 110, 160.

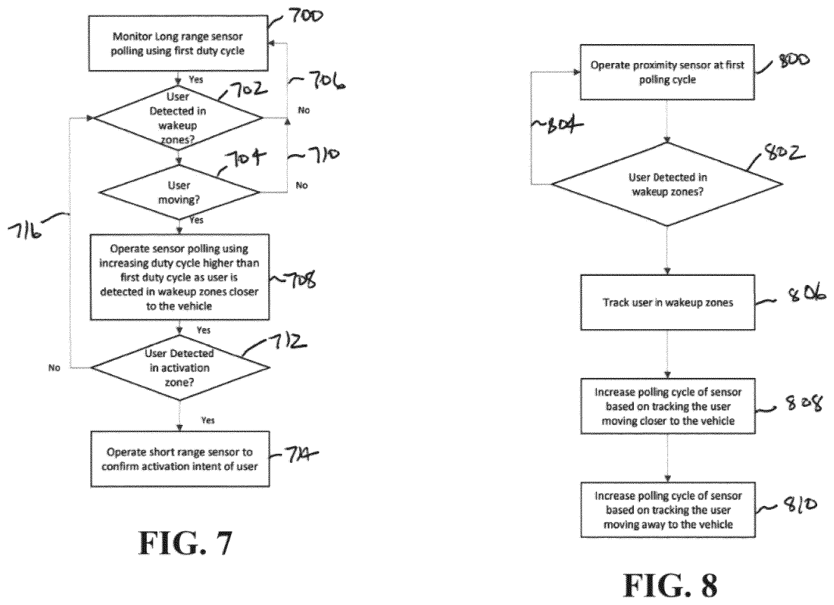

FIGS. 7-14 illustrate steps of a method for controlling a vehicle function of the vehicle 10. The method includes the step of sensing the position of a user 109 relative to a vehicle 10 using a proximity sensor 122. The method also includes the step of sensing an activation gesture of the user 109 using an activation sensor 123. The method also includes the step of modifying operation of the activation sensor 123 based on the position of the user 109 relative to the vehicle 10 detected using the proximity sensor 122 and controlling the vehicle function using a vehicle system 20, 110, 160 accordingly.

As discussed above, the at least one proximity sensor 122 is configured to detect the user 109 in one of the plurality of zones 107, 108 including the at least one short range proximity zone 107 adjacent the vehicle 10 and the plurality of medium or long range proximity zones 108 disposed increasing further away from the vehicle 10 than the least one short range proximity zone 107. The at least one proximity sensor 122 includes the at least one short range proximity sensor 122a, 122b for sensing the position of the user 109 relative to the vehicle 10 in the at least one short range proximity zone 107 and the at least one medium or long range proximity sensor 122c, 122d, 122e, 122f for sensing the position of the user 109 relative to the vehicle 10 in the plurality of medium or long range proximity zones 108. The at least one short range proximity sensor 122a, 122b is selected from the group comprising capacitive sensors 122a and close proximity PKE approach sensors 122b. The at least one medium or long range proximity sensor 122c, 122d, 122e, 122f selected from the group consisting of radar sensors 122c, optical sensors 122d, PKE/FOB sensors 122e, and GPS sensors 122f. Radar sensors may be doppler type radar or FMCW, or other sensor types which may be able to detect motion and distance of objects for example and without limitation.

Again, the plurality of zones 107, 108 includes the activation zone immediately adjacent the vehicle 10 and the plurality of wakeup zones further from the vehicle 10 than the activation zone. Referring specifically to FIG. 7, the method further includes the step of 700 monitoring the at least one medium or long range proximity sensor 122c, 122d, 122e, 122f using a first duty cycle. The method continues with the step of 702 determining whether the user 109 is detected in one of a plurality of wakeup zones. The next step of the method is 704 determining whether the user 109 is moving in response to the user 109 being detected in one of the plurality of wakeup zones. The method proceeds by 706 returning to monitoring the at least one medium or long range proximity sensor 122c, 122d, 122e, 122f using the first duty cycle in response to the user 109 not being detected in one of the plurality of wakeup zones. In addition, the method includes the step of 708 operating sensor polling of the at least one proximity sensor 122 using an increasing duty cycle higher than the first duty cycle as the user 109 is detected in the one of the plurality of wakeup zones closer to the vehicle 10 in response to determining the user 109 is moving. The method continues with the step of 710 returning to monitoring the at least one medium or long range proximity sensor 122c, 122d, 122e, 122f using the first duty cycle in response to determining the user 109 is not moving. Next, 712 determining whether the user 109 is detected in an activation zone. The next step of the method is 714 operating the at least one short range proximity sensor 122a, 122b to confirm activation intent of the user 109 in response to the user 109 being detected in the activation zone. The method also includes the step of 716 returning to determining whether the user 109 is detected in one of the plurality of wakeup zones in response to the user 109 being detected in the activation zone.

Referring specifically to FIG. 8, the method further includes the step of 800 operating the at least one proximity sensor 122 at a first polling rate. The method continues with the step of 802 determining whether the user 109 is detected in one of a plurality of wakeup zones. The method proceeds by 804 returning to operating the at least one proximity sensor 122 at the first polling rate in response to the user 109 not being detected in one of the plurality of wakeup zones. The next step of the method is 806 tracking the user 109 in the plurality of wakeup zones in response to user 109 being detected in one of the plurality of wakeup zones. The method also includes the step of 808 increasing a polling rate of the at least one proximity sensor 122 beyond the first polling rate based on tracking the user 109 moving closer to the vehicle 10. The method continues with the step of 810 decreasing the polling rate of the at least one proximity sensor 122 to be less than the first polling rate based on tracking the user 109 moving away from the vehicle 10.

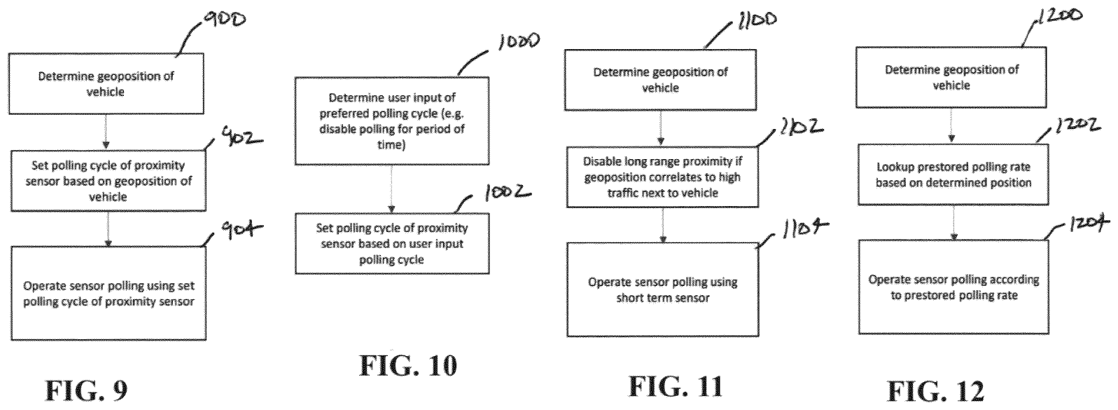

According to an aspect, the method further includes the step of decreasing a polling rate of the at least one proximity sensor 122 in response to the user 109 stopping movement relative to the vehicle 10 for a predetermined stopping time. Referring specifically to FIG. 9, the method further includes the step of 900 determining the vehicle position of the vehicle 10 using at least one of GPS sensors 122f and a vehicle global positioning system unit 600. The method continues with the step of 902 setting a polling rate of the at least one proximity sensor 122 based on the vehicle position of the vehicle 10. The method also includes the step of 904 operating the at least one proximity sensor 122 using the polling rate set.

Referring specifically to FIG. 10, the method further includes the step of 1000 determining a user input of a preferred polling rate using a user interface 599. The method also includes the step of 1002 setting a polling rate of the at least one proximity sensor 122 based on the user input of the preferred polling rate.

Referring specifically to FIG. 11, the method further includes the step of 1100 determining the vehicle position of the vehicle 10 using at least one of the GPS sensors 122f and the vehicle global positioning system unit 600. The method also includes the step of 1102 disabling the at least one medium or long range proximity sensor 122c, 122d, 122e, 122f if the vehicle position correlates to high traffic next to the vehicle 10. The method continues with the step of 1104 polling the at least one short range proximity sensor 122a, 122b.

Referring specifically to FIG. 12, the method further includes the step of 1200 determining the vehicle position of the vehicle 10 using at least one of the GPS sensors 122f and the vehicle global positioning system unit 600. The method continues with the step of 1202 looking up a prestored polling rate based on the vehicle position. The method also includes the step of 1204 operating at least one proximity sensor 122 using the prestored polling rate.

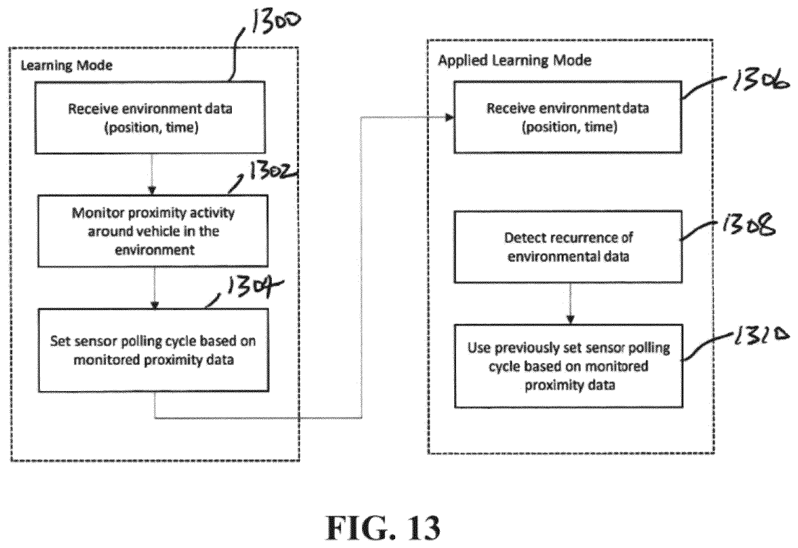

Referring specifically to FIG. 13, the method further includes the step of 1300 receiving environment data in a learning mode. The next step of the method is 1302 monitoring proximity activity around the vehicle 10 in the environment in the learning mode. The method proceeds by 1304 setting a polling rate of the at least one proximity sensor 122 based on the proximity activity monitored around the vehicle 10 in the learning mode. Next, 1306 receiving the environment data in an applied learning mode. The method continues with the step of 1308 detecting a recurrence of the environment data in the applied learning mode. The method also includes the step of 1310 using the polling rate of the at least one proximity sensor 122 set based on the proximity activity monitored around the vehicle 10 in the applied learning mode.

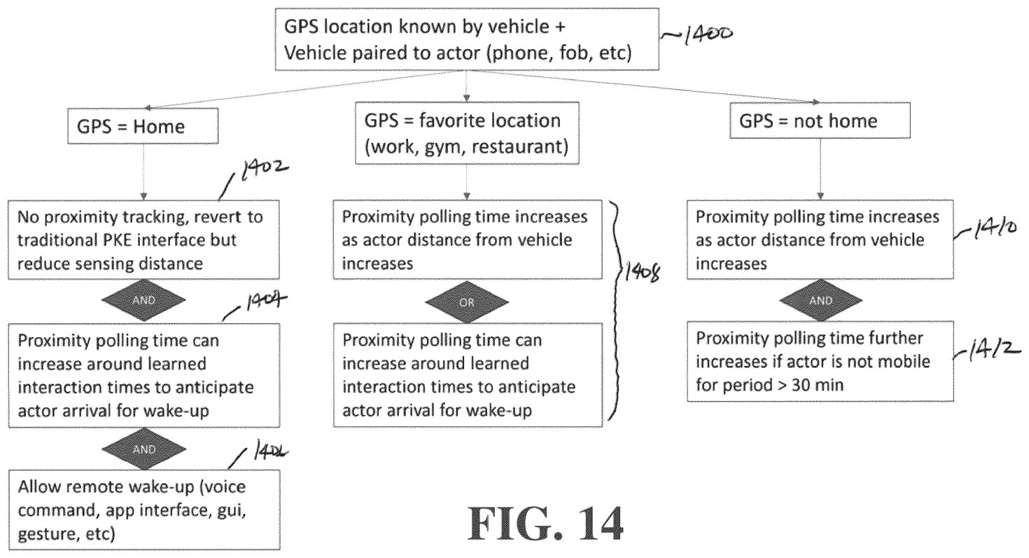

Referring specifically to FIG. 14, the method further includes the step of 1400 determining the vehicle position of the vehicle 10 using at least one of GPS sensors 122f and a vehicle global positioning system unit 600 and whether the vehicle 10 is paired to at least one of a mobile phone 231 and a key fob 230. Next, 1401 determining the vehicle position is a home position. The method proceeds by 1402 in response to determining the vehicle position is the home position, disabling proximity tracking the at least one proximity sensor 122 and reverting to a traditional PKE interface with a reduced sensing distance. The method continues with the step of 1404 in response to determining the vehicle position is the home position, increasing a polling rate of the at least one proximity sensor 122 around learned interaction times to anticipate arrival of the at least one of the mobile phone 231 and the key fob 230 for wakeup. The next step of the method is 1406 in response to determining the vehicle position is the home position, allowing remote wakeup. The next step of the method is 1407 determining the vehicle position is a favorite location position. Next, 1408 in response to determining the vehicle position is the favorite location position, increasing the polling rate of the at least one proximity sensor 122 based on one of the at least one of the mobile phone 231 and the distance of the key fob 230 from the vehicle 10 increasing and around learned interaction times to anticipate arrival of the at least one of the mobile phone 231 and the key fob 230 for wakeup. Next, 1409 determining the vehicle position is not the home position. The method proceeds by 1410 in response to determining the vehicle position is not the home position, increasing the polling rate of the at least one proximity sensor 122 as the at least one of the mobile phone 231 and the key fob 230 distance from the vehicle 10 increasing. The method also includes the step of 1412 in response to determining the vehicle position is not the home position, further increasing the polling rate of the at least one proximity sensor 122 if the at least one of the mobile phone 231 and the key fob 230 is not mobile for a predetermined immobile time. The mobile phone and key fob 230 are examples of things the user has or things the user owns, for identifying the user, and may further include examples of wearable technology. Further things the user has may include physical attributes such as facial features which can be detected using facial recognition based sensors and algorithms.

A vehicle power door(s) control strategy can then include vehicle location information, time and the ability to remember previous vehicle trip occupant information 1600. These 3 variables can aid understanding/infer the intent of the users 109 or operators to access a vehicle 10 (e.g. intent to open a door 12, 17) while interacting the vehicle 10. Understanding the intent of the user 109 will allow the powered door (PD) system (i.e., actuator or actuator unit 22) controlled by controller 26 to execute needed functions more efficiently and with less interaction from the user 109. In essence, the vehicle 10 will be able to anticipate user needs based on the location, time and previous ride history. Artificial intelligence control used in such a method if also provided. Aspects provided herein include: 1) the system 100 will understand vehicle GPS location, 2) the system 100 will understand time, 3) the system 100 will remember previous trip information to determine actions required for next trip, and 4) current trip occupant information to determine actions for end of trip will be determined by the system 100. Thus, according to an aspect, the system 100 includes a sensor 122 for sensing at least one of an activation gesture of a user 109 and a proximity of the user 109 to the vehicle 10. The system 100 can include a vehicle system or access system 20, 110, 160 for controlling the vehicle function. A controller 26 has a memory unit 530 and is in communication with the sensor 122 and with the vehicle system 20, 110, 160. The controller 26 is configured to store data relating to a previous operation of the vehicle function and subsequently control the vehicle system 20, 110, 160 based on the previously stored data. According to another aspect, the controller 26 is further configured to monitor data relating to a current operation of the vehicle function and subsequently control the vehicle system 20, 110, 160 based on the currently monitored data.

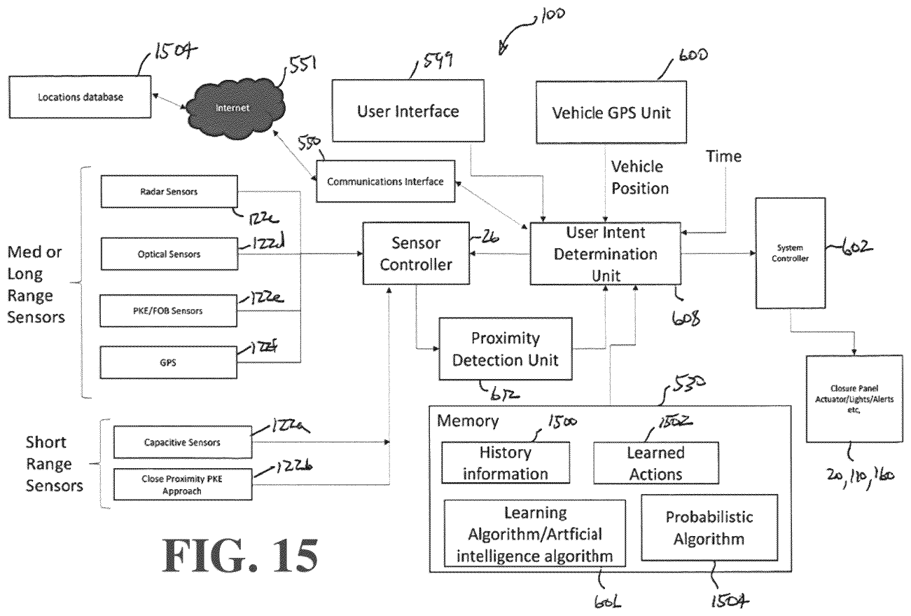

FIG. 15 is yet another block diagram illustrating the system 100. FIG. 15 is similar to FIG. 4, however, the memory 530 includes history information 1500 and learned actions 1502 and the learning algorithm 606 and a probabilistic algorithm 1504. In addition, the system 100 also includes the communications interface or interface device 550 configured to connect to a locations database 1506 via the network 551 (e.g., the internet).

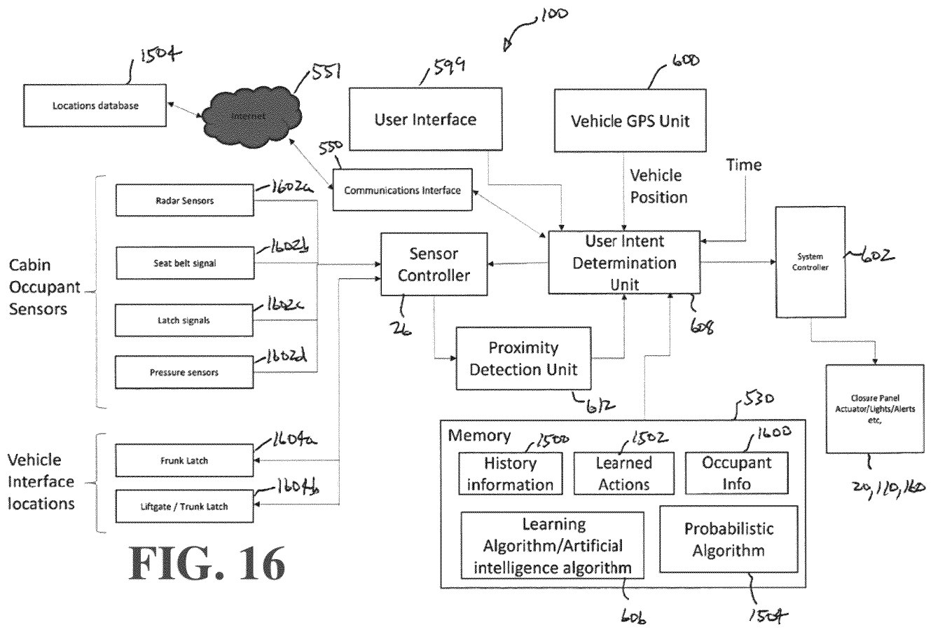

FIG. 16 is a further block diagram illustrating the system 100. FIG. 16 is also similar to FIGS. 4 and 15, however, the memory 530 includes history information 1500 and learned actions 1502 and a learning algorithm 606 and a probabilistic algorithm 1504 and occupant info 1600. The system 100 also includes at least one cabin occupant sensor 1602 configured to sense occupants of a cabin of the vehicle 10 selected from a group comprising radar sensors 1602a, seat belt sensors 1602b, latch sensors 1602c, and pressure sensors 1602d. The system 100 additionally includes at least one vehicle interface location sensor 1604 configured to sense an interface of the vehicle 10, the at least one vehicle interface location sensor 1604 selected from a group comprising a frunk latch sensor 1604a and lift gate latch sensor 1604b.

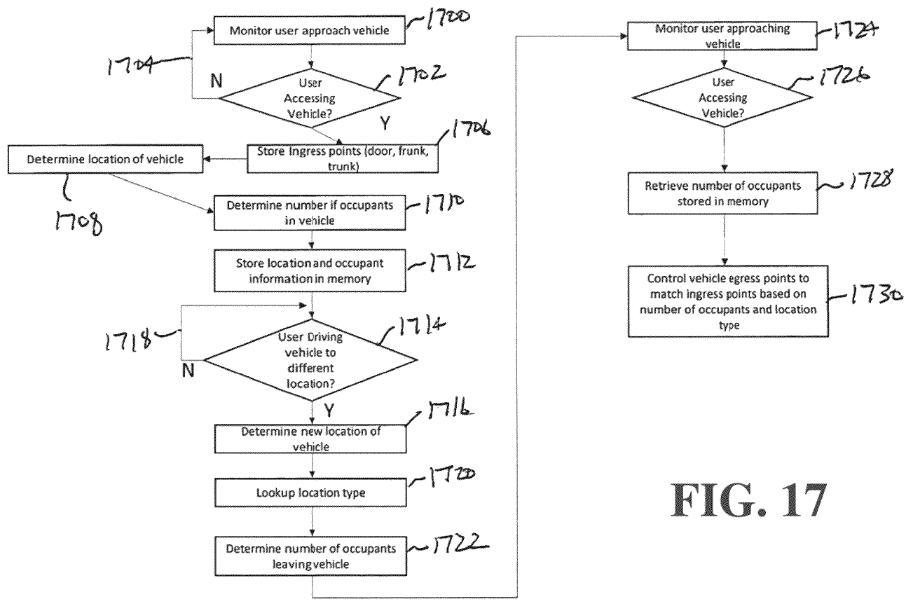

FIGS. 17-19 illustrate steps of another method for controlling the vehicle function of the vehicle 10. The method includes the step of sensing at least one of an activation gesture of a user 109 and a proximity of the user 109 to the vehicle 10 using a sensor. The method also includes the step of storing data relating to a previous operation of the vehicle function controlled by a vehicle system 20, 110, 160 and subsequently control the vehicle system 20, 110, 160 based on previously stored data.

GPS locations can be programmed into the vehicle 10 (e.g., memory 530) or can be determined from points of interest labels in normal GPS services. When the vehicle 10 is at all locations except home (e.g. the user's house or most time spent parked at a location), a user approaching the vehicle 10 has intent of accessing vehicle 10. If the system 100 knows GPS location (i.e., vehicle position), it is able to execute functions that align with specific locations. For example, if the GPS location is determined to be the user's place of work, then probabilistically the controller 26 determines it is very likely that only one door will require access, such as the driver's door 12 when the user 109 is detected to be approaching the vehicle 10. The system 100 only needs to monitor about a single door and open accordingly. Conversely, if the GPS location is determined to be a sports venue; it is likely that multiple doors 12, 17 will require access. So, the system 100 can monitor multiple doors 12, 17 for user 109 approaches.

Thus, referring specifically to FIG. 17, the method further includes the step of 1700 monitoring an approach of a user 109 to the vehicle 10. The method proceeds by 1702 determining whether the user 109 is accessing the vehicle 10. The method continues with the step of 1704 returning to monitoring the approach of the user 109 to the vehicle in response to determining the user 109 is not accessing the vehicle 10. The next step of the method is 1706 storing a plurality of vehicle ingress points in response to determining the user 109 is accessing the vehicle 10. The method proceeds by 1708 determining a vehicle location of the vehicle 10. Next, 1710 determining a number of occupants of the vehicle 10. The method continues with the step of 1712 storing a location and occupant information 1600 in memory 530. In addition, the method includes the step of 1714 determining whether the user 109 is driving the vehicle 10 to a different location. The next step of the method is 1716 determining new location of vehicle 10 in response to determining the user 109 is driving the vehicle 10 to the different location. The method proceeds by 1718 returning to determining whether the user 109 is driving the vehicle 10 to the different location in response to determining the user 109 is not driving the vehicle 10 to the different location. The method continues with the step of 1720 looking up a location type of the new location from a locations database 1506 via the network 551. Next, 1722 determining how many of the occupants leave the vehicle 10 and updating the number of occupants. The next step of the method is 1724 monitoring the user 109 approaching the vehicle 10. Additionally, the method includes the step of 1726 determining whether the user 109 is accessing the vehicle 10. The method continues with the step of 1728 retrieving the number of occupants stored in the memory 530 in response to determining the user 109 is accessing the vehicle 10. The method also includes the step of 1730 controlling a plurality of vehicle egress points to match the plurality of vehicle ingress points based on the number of occupants and the location type.

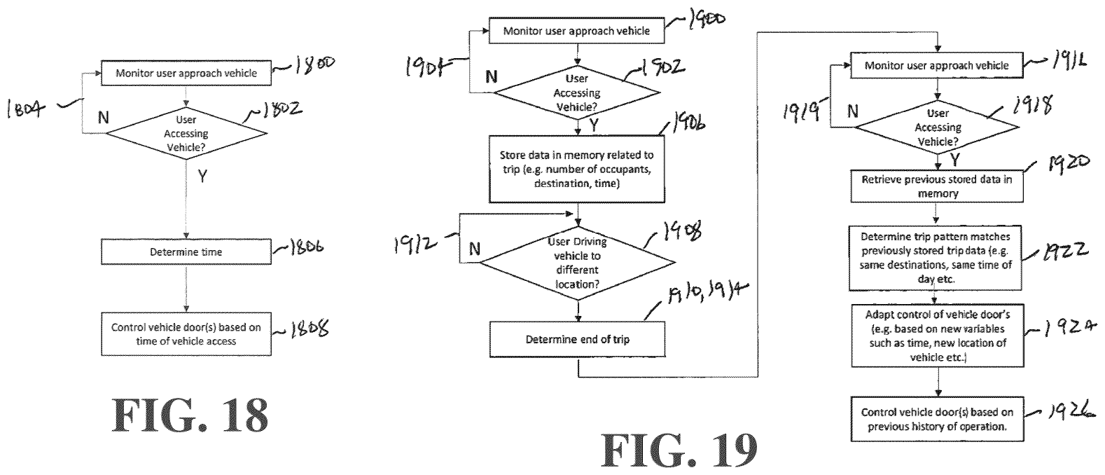

By adding time component to the GPS signal, further refinement to intent can be determined. For example the GPS location is “restaurant”; and the time is after midnight, it is likely that only the front doors 12 will require access (i.e., no kids). Also, the system 100 needs to monitor only the front doors 12 for functional response. If the GPS signal is “school” and the time is 4 pm, it is likely front and rear doors 12, 17 will require access. The system 100 can monitor for occupants accordingly. So, referring specifically to FIG. 18, the method further includes the step of 1800 monitoring an approach of a user 109 to the vehicle 10. The next step of the method is 1802 determining whether the user 109 is accessing the vehicle 10. The method continues with the step of 1804 returning to monitoring the approach of the user 109 to the vehicle 10 in response to determining the user 109 is not accessing the vehicle 10. Next, 1806 determining a time of vehicle access in response to determining the user 109 is accessing the vehicle 10. The method also includes the step of 1808 controlling doors of the vehicle 10 based on the time of vehicle access.

By recording a previous trip history, even further refinement to understanding intent can be achieved by recalling the previous trip details, such as may be stored in memory 530. For example, if 4 people leave a house/home (e.g., internal occupant monitoring system determines four persons are seated in vehicle 10; and GPS arrival location is determined to be a shopping center, it is very likely, or a high probability, that 4 people will return to the vehicle 10. Based on this high likelihood, the controller 26 will infer that each occupant will required a door 12, 17 to be opened, and as such the system 100 can monitor the approach of user's towards all of the door 12, 17 e.g. 4 doors. As another example, if one person enters the vehicle 10 when the user 109 enters from its home, and the GPS location upon exist of the vehicle 10 is at a gym, or not at home, it is very likely that only one person will return to the vehicle 10. The system 100 only needs to monitor for approach around a single door 12, 17. Previous trip information can also be used to enhance access to a Frunk or powered liftgate (PLG) system. If the occupant accessed the Frunk/PLG before opening the driver's side door 12, it is likely that access to the same compartment may be needed at arrival, e.g. at a gym location or a work location. When the occupant exits the door 12, the appropriate compartment can be opened in anticipation of egress request.

For end of trip function, yet further refinement to the understanding intent can be achieved when the system 100 obtains cabin information about users seating to operate only the doors 12, 17 required. To execute this feature requires the ability of the system 100 to determine occupation status of each seat during the trip. This can be accomplished using in cabin radar sensor, seatbelt user information, door latch state change information etc. At the end of the trip, doors 12, 17 can open based on occupant seating locations.

Integrating information such as GPS location, time, previous trip history, and end of trip function will allow controller 26 to predict required actions related to the door 12, 17 with higher degree of confidence allowing the system 100 to provide unimpeded access/egress to users 109.

Thus, referring specifically to FIG. 19, the method further includes the step of 1900 monitoring an approach of a user 109 to the vehicle 10. The next step of the method is 1902 determining whether the user 109 is accessing the vehicle 10. The method proceeds by 1904 returning to monitoring the approach of the user 109 to the vehicle 10 in response to determining the user 109 is not accessing the vehicle 10. In addition, the method includes the step of 1906 storing trip data in memory 530 in response to determining the user 109 is accessing the vehicle 10. The next step of the method is 1908 determining whether the user 109 is driving the vehicle 10 to a different location. The method continues with the step of 1910 determining new location of vehicle 10 in response to determining the user 109 is driving the vehicle 10 to the different location. Next, 1912 returning to determining whether the user 109 is driving the vehicle 10 to the different location in response to determining the user 109 is not driving the vehicle 10 to the different location. The method proceeds by 1914 determining an end of a trip in response to determining the user 109 is driving the vehicle 10 to the different location. Additionally, the method includes the step of 1916 monitoring the user 109 approaching the vehicle 10. The method continues with the step of 1918 determining whether the user 109 is accessing the vehicle 10. The method proceeds by 1919 returning to monitoring the user 109 approaching the vehicle 10 in response to determining the user 109 is accessing the vehicle 10. In addition, the method includes the step of 1920 retrieving trip data stored in the memory 530 in response to determining the user 109 is accessing the vehicle 10. Next, 1922 determining whether the trip data matches a previously stored trip data. The method continues with the step of 1924 adapting control of doors of the vehicle 10 based on the trip data and the previously stored trip data. The method also includes the step of 1926 controlling the doors of the vehicle 10 based on the trip data and the previously stored trip data.

According to an aspect, yet another method for controlling a vehicle function of a vehicle 10 is provided. The method includes the step of determining operation of a vehicle system 20, 110, 160 in response to detecting a user 109 using a sensor for sensing an activation gesture or proximity of the user 109 to the vehicle 10. The method also includes the step of storing the parameters associated with the operation of the vehicle system 20, 110, 160. The next step of the method is controlling operation of the vehicle system 20, 110, 160 in response to subsequently detecting a user 109 using the sensor based on the stored parameters associated with the operation of the vehicle system 20, 110, 160. According another aspect, the data relating to the previous operation of the vehicle function includes a number of occupants and a destination and a time.

It is desirable to provide “unimpeded access” to the motor vehicle 10, that is how to open the door 12 with the minimal positive action by a user 109. A positive action could be for example, the user 109 making a positive intentional gesture. But this positive action decreases the seamless natural of access for the user 109. Some existing systems look for a “predetermined gesture” to be matched with a gesture being made in a designated detection zone. However, gestures have to be remembered which is a drawback. Identifying approach of the user 109 is preferable, but the challenge is to differentiate an approach to the vehicle 10 with intent to access, compared to one that has no intent. For example, the user 109 mowing the yard next to the vehicle 10 when they have their FOB 230 in their pocket.

FIG. 20 is another block diagram illustrating another system 2000 for controlling a vehicle function of the vehicle 10 of FIG. 1. The system 2000 includes a vehicle unit 2002 with an optical sensor 122d (e.g., camera) for detecting objects and gestures, for example, an ultra wideband sensor 122g, and a plurality of control switches 2004 (e.g., lock and unlock, etc.). The vehicle unit 2002 connects to the body control module 27 which is in communication with the latch 110, an applique 2006, the outside handle 29, the inside handle 31, side mirror 21 and the controller 26 and user intent determination unit 608. The outside handle 29 is configured to provide open/unlock request and actor (i.e., user 109) feedback functionality, for example. The inside handle 31 is configured to provide child lock and open/unlock request functionality, for example. The body control module 27 is configured to provide central locking, wakeup on approach, authentication of the user 109, intention of the user 109 (non PD generated), vehicle module info, driver feedback, and child lock functionality, for example. The side mirror 21 additionally connects to the controller 26 and user intent determination unit 608. The controller 26 and user intent determination unit 608 include a smart access decision unit 2001 (software and/or hardware) and are configured to provide intention, backup authentication, and backup wakeup functionality, for example. The side mirror 21 is configured to provide actor feedback, backup power (>72 hours) and object and gesture detection, for example. The at least one light 160 includes a plurality of lights 160 in the side mirror 21 and in the outside handle 29. The controller 26 and at least one system controller 602 connect to a vehicle power source 2008 (e.g., battery), which also connects to the user intent determination unit 608. The controller 26 and at least one system controller 602 also connect to the power closure member system 20 including the power operated actuator mechanism or actuator unit 22. In addition, the controller 26 and at least one system controller 602 are in communication with the inside handle, the latch 110, and the user intent determination unit 608. The controller 26 and at least one system controller 602 are configured to provide open/close motion of the door 12, latch control, infinite check, haptronic control, vehicle grade, and backup wakeup functionality, for example. The outside handle 29 and applique additionally connect to the user intent determination unit 608. The outside handle 29 includes the at least one short range proximity sensor 122a, b (e.g., non-contact obstacle detection sensor/NCOD). The applique 2006 includes a near field communication (NFC)/Bluetooth low energy (BLE) sensor 122h, as well as a keypad 2010 and a PELI sensor 122i. The applique 2006 is configured to provide actor feedback, keypad entry, and open/unlock/lock request functionality, for example. The latch 110 includes an electric latch mechanism 110a and icebreaker 110b. The latch 110 is configured to provide lock/unlock, latch/unlatch, door 12 ajar, door 12 cinch, and backup power (<72 hour) functionality, for example.

So, for example, the vehicle access system 100, 2000 includes two or more sensors 122 for detecting at least one approach characteristic of the user 109. In addition, a controller 26, 608 is connected to the two or more sensors 122 and connected to the actuator unit 22. It is understood the vehicle access system 100, 2000 may include one or more sensors. The controller 26, 608 is adapted to determine a confidence level representative of an intent of the user 109 approaching the motor vehicle 10 to access the motor vehicle 10 based on the at least one approach characteristic of the user 109 and control the actuator unit 22 based on the confidence level. Therefore user approach characteristics are analyzed and intent is inferred.

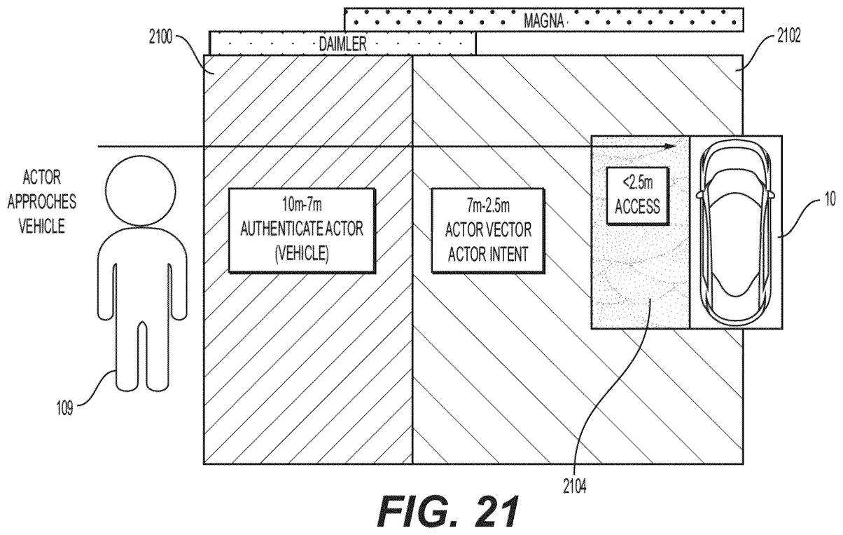

FIG. 21 illustrates an example of a predetermined authentication distance 2100, a predetermined sensing distance 2102, and a predetermined access distance 2104 relative to the motor vehicle 10. As shown, the user 109 or actor approaches the vehicle 10 and the controller 26, 608 is further configured to control the access system 20, 110, 160 based on the determined intent occurs when the user 109 is detected to be within the predetermined access distance 2104 (e.g., <2.5 meters) from the motor vehicle 10. The controller 26, 608 is also configured to detect, using the two or more sensors 122, the at least one approach characteristic of the user 109 when the user 109 is detected to be within the predetermined sensing distance 2102 (e.g., 2.5-7 meters) beyond the predetermined access distance 2104 from the motor vehicle 10. The controller 26, 608 is further configured to detect, using the two or more sensors 122, the at least one approach characteristic of the user 109 in response to an authentication of the user 109 at the predetermined authentication distance 2100 (e.g., 7-10 meters) beyond the predetermined sensing distance 2102 from the motor vehicle 10. The controller 26, 608 may further be configured to control the access system 20, 110, 160 based on detecting a gesture adjacent the motor vehicle 10 after the intent of the user 109 to access the motor vehicle 10 is determined. In addition, the controller 26, 608 is further configured to detect, using the two or more sensors 122, the at least one approach characteristic of the user 109 using at least two different types of sensors 122.

According to another aspect, one or more sensors 122 for detecting at least one approach characteristic of the user 109 may be used instead of the two or more sensors 122. In addition, the controller 26, 608 is adapted to determine a confidence level representative of the intent of the user 109 approaching the motor vehicle 10 to access the motor vehicle 10 based on the at least one approach characteristic of the user 109. The controller 26, 608 is also configured to determine a sensor performance level of the one or more sensors 122 and adjust the confidence level based on the determined sensor performance level. The controller 26, 608 then controls the actuator unit 22 based on the adjusted confidence level. The controller 26, 608 may be further configured to determine an overall confidence level of the intent of the user 109 to access the motor vehicle 10. Additionally, the controller 26, 608 can be further configured to determine a sensor performance level for the at least one sensors 122, wherein the overall confidence level is a function of the sensor performance level determined. The at least one approach characteristic of the user 109 may include a plurality the approach characteristics of the user 109 and the controller 26, 608 is further configured to determine individual confidence levels for each of the plurality of approach characteristics of the user 109 detected. So, after the approach characteristics are identified, confidence values may be assigned to each sensor signal which may be used in an overall confidence score.

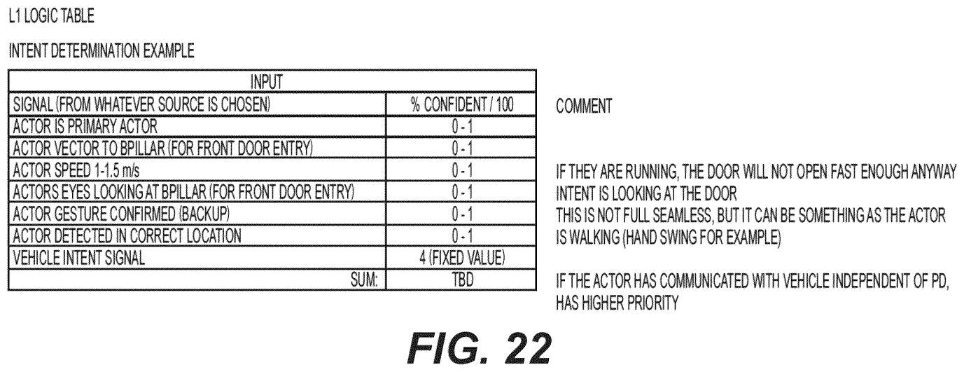

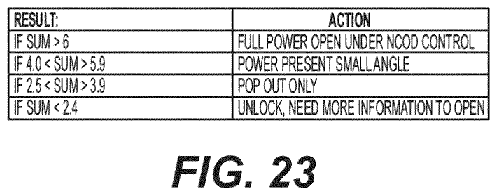

The controller 26, 608 is further configured to determine the intent of the user 109 to access the motor vehicle 10 using the at least one approach characteristic detected based on at least one of the individual confidence levels being above a predetermined confidence level. In addition, the controller 26, 608 can be configured to determine the intent of the user 109 to access the motor vehicle 10 using the at least one approach characteristic detected based on a sum of individual confidence levels. FIG. 22 shows a table of example approach characteristics, their respective individual confidence levels, and the sum of individual confidence levels. FIG. 23 is a table illustrating example actions based on the sum of individual confidence levels, also referred to as sub-confidence levels. Regarding the user 109 or actor speed, if they are running, the door 12 will not close fast enough anyway. Regarding the actor eyes looking at the B pillar, this shows intent by looking at the door 12. The actor gesture confirmed may not be fully seamless, but it can be something as the user 109 is walking (e.g., hand swinging). Regarding the vehicle intent signal, if the user 109 has communicated with the vehicle 10 independent of PD, it can have a higher priority.

Furthermore, the controller 26, 608 can be further configured to determine the intent of the user 109 to access the motor vehicle 10 using the at least one approach characteristic detected based on a weighted sum of the individual confidence levels as one possible configuration. For example, weighting of individual sensor confidence values in the decision sum can be adjusted to reflect the importance of the characteristic's data which each sensor represents. For example if actor vector is more important that actor speed, then actor vector can be more heavily weighted. The controller 26, 608 may also be configured to control different functions of the access system 20, 110, 160 based on a determined level of intent of the user 109 to access the motor vehicle 10.

According to another aspect, the controller 26, 608 may also be adapted to determine at least one approach vector representative of the intent of the user 109 approaching the motor vehicle 10 to access the motor vehicle 10 based on the at least one approach characteristic of the user 109 and control the actuator unit 22 based on the intent of the user 109 to access the motor vehicle 10 inferred from the at least one approach vector. In addition, the at least one approach characteristic of the user 109 can include a speed of approach of the user 109 towards the motor vehicle 10, a location of the user 109 while approaching the motor vehicle 10, a gaze of the user 109 approaching the motor vehicle 10. So, the controller 26, 608 is configured to determine the intent of the user 109 to access the motor vehicle 10 using the detected at least one approach characteristic without a detected gesture performed by the user 109. Thus, with system 100, 2000, the user approach does not need to be the same, (or exactly repeated) all the time since multiple approach characteristics are analyzed.

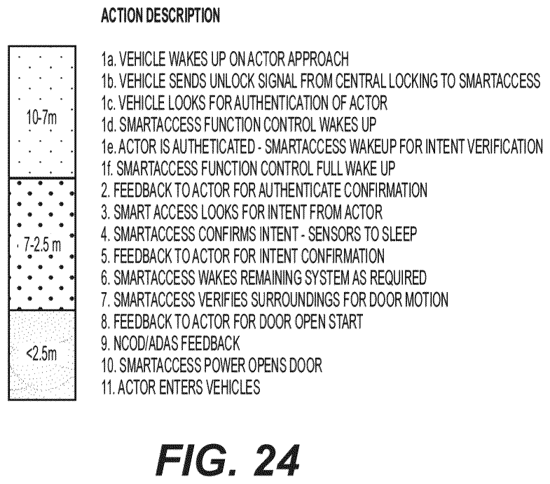

According to yet another aspect, the controller 26, 2000 is adapted to determine a level of intent of the user 109 based on receiving a signal from the one or more sensors 122, and control the access system 20, 110, 160 differently based on the level of intent of the user 109 determined being different. Specifically, the controller 26, 608 is further configured to control different functions of the access system 20, 110, 160 based on a determined level of intent of the user 109 to access the motor vehicle 10. The controller 26, 608 controls increased functionality at each of plurality of functional levels of the access system 20, 110, 160 as the determined level of intent is increased. So, the system 100, 2000 may not necessarily act in an all or nothing fashion, but may control the access system 20, 110, 160 differently based on the confidence it has correctly inferred the intent. FIG. 24 shows example actions or functions that may be completed at each of the predetermined authentication distance 2100, the predetermined sensing distance 2102, and the predetermined access distance 2104.

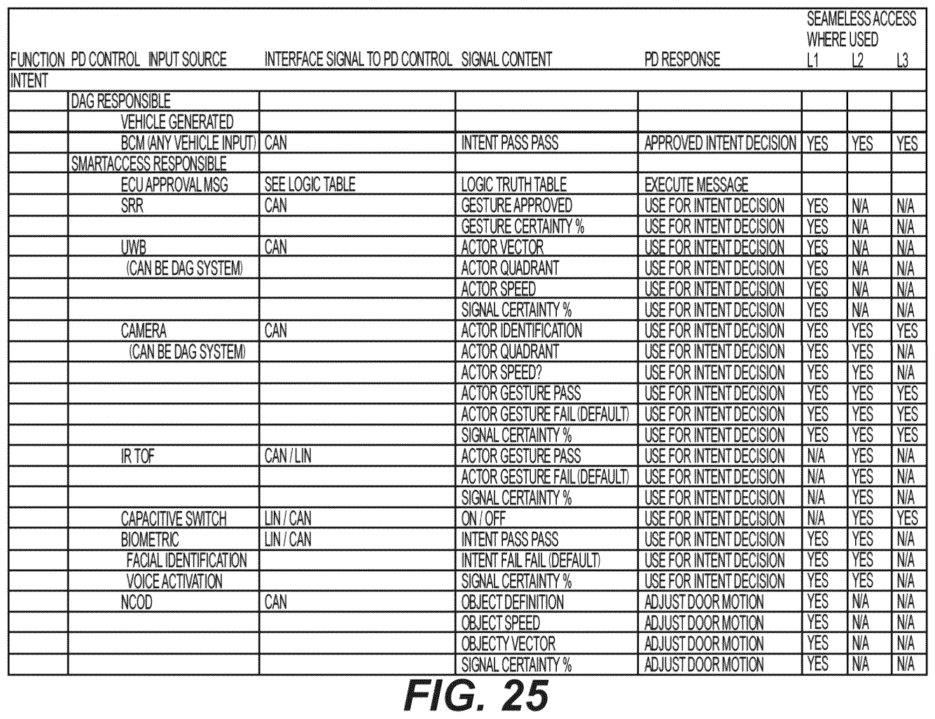

The plurality of functional levels of the access system 20, 110, 160 can include a first functional level L1 with a maximum functionality of the access system 20, 110, 160 and a second functional level L2 with reduced amount of the functionality of the access system 20, 110, 160 compared to the first functional level L1 and a third functional level L3 with a further reduced functionality of the access system 20, 110, 160 compared to the second functional level L2. FIGS. 25-28 show more details regarding the first functional level L1, and the second functional level L2, and the third functional level L3. Specifically, FIG. 25 shows a table including a plurality of power door (PD) control input sources, interface signals to the PD control (e.g., controller 26, 608), signal content, PD control (e.g., controller 26, 608) response, and when applicable to the first functional level L1, and the second functional level L2, and the third functional level L3.

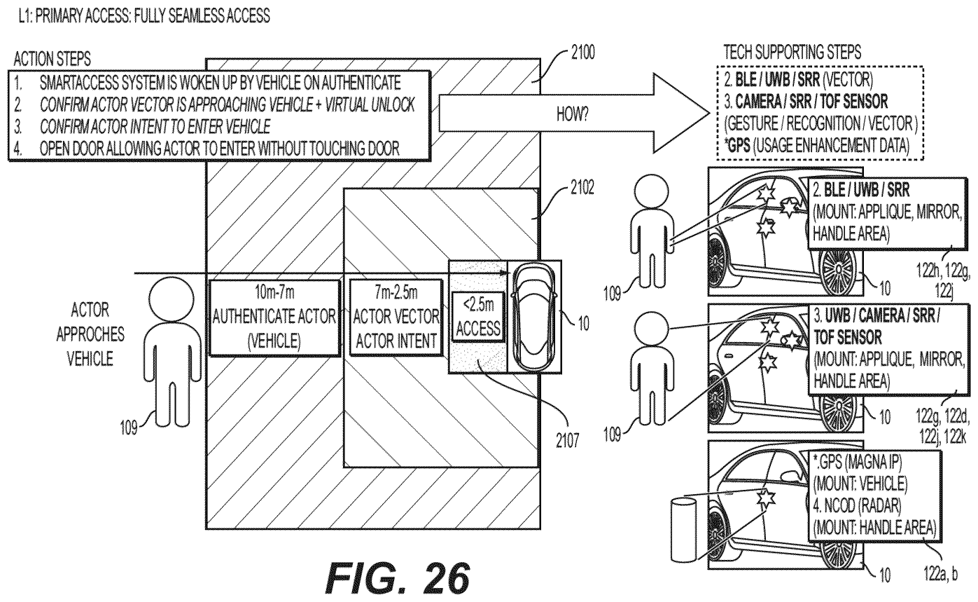

FIG. 26 shows more details about the first functional level L1 including the types of sensors 122 used. So, as shown the system 100, 2000 (e.g., controller 26, 608) is woken up by the vehicle once the user 109 is authenticated (e.g., at the predetermined authentication distance 2100). The controller 26, 608 then confirms the approach vector of the user 109 approaching the vehicle (e.g., using the Bluetooth low energy (BLE) sensor 122h, ultra wideband sensor 122g, and/or a microware SRR sensor 122j). The camera or optical sensor 122d and/or a time of flight (TOF) sensor 122k and NCOD sensor 122a, b may also be used. The controller 26, 608 confirms the intent of the user 109 to enter the vehicle 10 and opens the door 12 (using the actuator unit 22) allowing the user 109 to enter without touching the door 12.

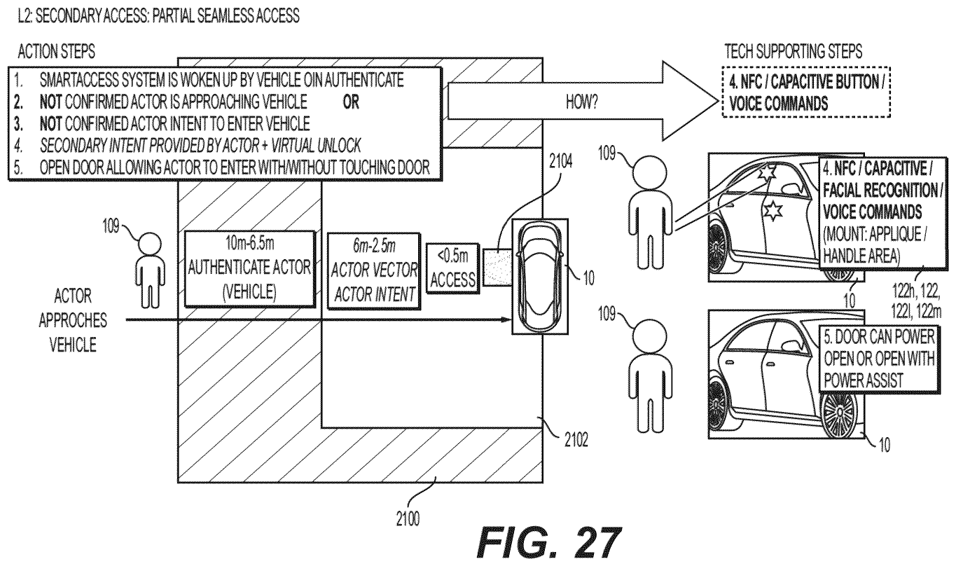

FIG. 27 shows more details about the second functional level L2 including the types of sensors 122 used. As shown the system 100, 2000 (e.g., controller 26, 608) is woken up by the vehicle once the user 109 is authenticated (e.g., at the predetermined authentication distance 2100). The controller 26, 608 does not confirm the approach vector of the user 109 approaching the vehicle or intent to enter the vehicle 10. However, a secondary intent is provided by the user 109 using the NFC sensor 122h, capacitive sensors 122, facial recognition sensors 1221, or voice recognition sensors 122m. The controller 26, 608 opens the door 12 (using the actuator unit 22) allowing the user 109 to enter without touching the door 12.

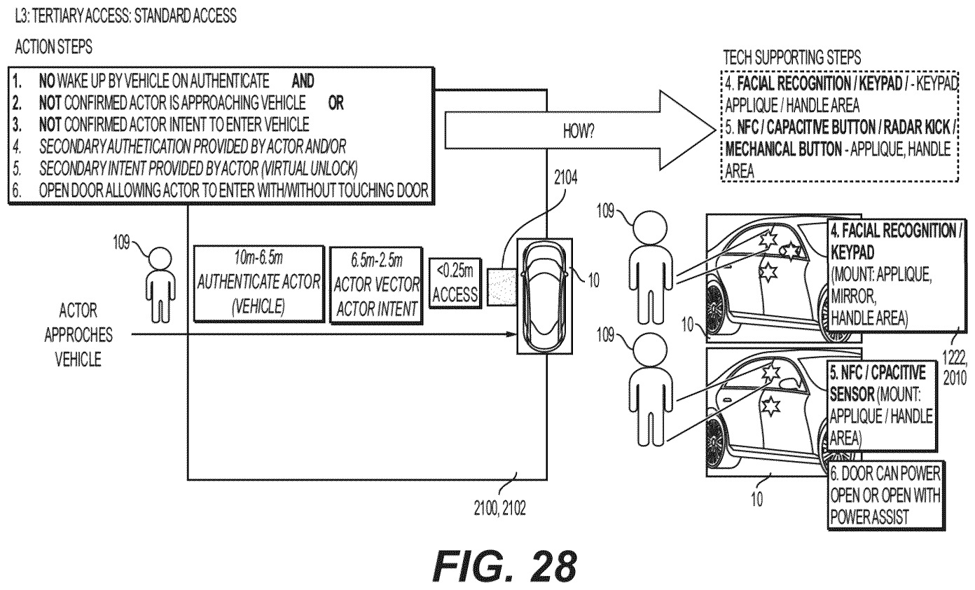

FIG. 28 shows more details about the third functional level L3 including the types of sensors 122 used. As shown the system 100, 2000 (e.g., controller 26, 608) is not woken up by the vehicle once the user 109 is authenticated (e.g., at the predetermined authentication distance 2100). The controller 26, 608 also does not confirm the approach vector of the user 109 approaching the vehicle or intent to enter the vehicle 10. However, a secondary authentication and/or a secondary intent is provided by the user 109 using the NFC sensor 122h, capacitive sensors 122, facial recognition sensors 1221, or keypad 2010. The controller 26, 608 opens the door 12 (using the actuator unit 22) allowing the user 109 to enter without touching the door 12.

According to yet another aspect, the controller 26, 2000 is adapted to determine an intent of the user 109 using the at least one approach characteristic of the user as well as using the state of the vehicle. The state of the vehicle may include data related to geo-position of the vehicle and to the environmental state of the vehicle, such as weather conditions surrounding the vehicle for example. Environmental data may be collected using a sensor system local to the vehicle and/or using a communication system connected to external data sources, such as to a weather data server for example. The controller 26, 2000 may be configured to use vehicle state information or data to adjust the determined intent of the user.

For example the controller 26, 2000 may modify an overall determined confidence level as described herein by increasing or decreasing the determined confidence level based on the state of the vehicle. For example, when the state of the vehicle is determined to be, using the geo-location data of the vehicle, parked in a downtown core known for being a densely populated area where many people (non-unauthorized users) may be moving about the vehicle, the overall determined confidence level may be decreased e.g. from 6 to 2 so as to avoid a premature action of the access system 20, 110, 160. As a result, an authorized user may have to had to approach the vehicle during a lull in the presence other un-authorized users about the vehicle to provide confidence to the access system 20, 110, 160 that a correct user is seeking to gain access. Or, in order for the user to access the vehicle, a vehicle intent signal e.g. activation of a FOB, may now be required to access the vehicle based on the geo location.

For example, when the state of the vehicle is determined to be, using the geo-location data of the vehicle, parked in at the user's home address, the overall determined confidence level may be increased e.g. from 3 to 6 so as to avoid a non-action of the access system 20, 110, 160. For example, a user, while the vehicle is determined to be in a geolocation of home, may be determined to be a primary actor, moving towards the front door, moving at a speed between 1 to 1.5 m/s, and performing a correct activation gesture, yet however, be determined to be looking at his phone and performing the correct gesture in an incorrect location. The access system 20, 110, 160 may increase the confidence of the user having intent to access the vehicle based on the geo-location and increase the level to provide a full power open under NCOD control. Since the user is at home, the risk of incorrect action is lesser since it is less likely other pedestrians may be impacts by the closure panel or an adjacent car, or that an unauthorized user may access the vehicle while the vehicle is at a home position. Such an adjustment based on the geolocation of the vehicle may also include adjusting sub-confidence values in the decision sum by providing for a weighting of individual sub-confidence values. For example, if the geolocation of the vehicle is determined to be a grocery store parking lot, the approach vector and speed inputs may be increased weighted to compensate for an unlikely gesture activation by a user assuming the user is carrying groceries due to visiting the grocery store. Such an adjustment may also be based on the environmental state of the vehicle, such as the weather. For example, if the temperature and weather conditions of the vehicle is determined to be a cold and raining, the approach vector and speed inputs may be increased weighted to compensate for an unlikely gesture activation by a user assuming the user is carrying an umbrella due to the rain, of has their hands in their pockets due to the lower temperature.

As another example, the controller 26, 2000 may be configured to modify inputs used to determine intent of the user based on the state of the vehicle, such as modify the predetermined authentication distance 2100, the predetermined sensing distance 2102, and the predetermined access distance 2104, by either increasing and/or decreasing such distances. For example, when the state of the vehicle used by the controller 26, 2000 to assist with inferring the intent of the user to access the vehicle is the geo-location of the vehicle determined to be at a home location of the user of the vehicle, the controller 26, 2000 may decrease the predetermined authentication distance 2100 since it is likely the user may more often be moving about the vehicle at home without having the intent to access the vehicle, such as if the vehicle is parked in a garage the user often accesses the garage for running errands without accessing the vehicle. Or for example if the user's living room is above a garage in which the vehicle is parked. The predetermined sensing distance 2102, and the predetermined access distance 2104 may also be decreased to avoid power drain of the system from frequent movement of the user about the vehicle at home without having intent to access the vehicle. For example, when the state of the vehicle used by the controller 26, 2000 to assist with inferring the intent of the user to access the vehicle is the geo-location of the vehicle determined to be at a parking lot location of the user of the vehicle and inclement weather has been determined, the controller 26, 2000 may increase the predetermined authentication distance 2100, and the predetermined sensing distance 2102, and the predetermined access distance 2104 having inferred that the user's intent when his approach is detected will be to access the vehicle rapidly to shelter from the inclement weather.

Further, the controller 26, 2000 may be configured to modify the response e.g. control the to control the vehicle system 20, 110, 160 or vehicle function, subsequent to having inferred the intent of the user to access the vehicle based on the state of the vehicle. For example, the controller 26, 2000 based on the geo-location of the vehicle if determined to be in a busy center downtown area next to a side walk with high density may determine to only move the door to presented position as opposed to a fully opened position so as not to obstruct a sidewalk and strike pedestrians. For example, the controller 26, 2000 based on the environment of the vehicle if determined to be in a windy may determine to only move the door to presented position as opposed to a fully opened position so avoid the wind catching the door which could damage the power door actuator.

Thus, user convenience is enhanced by adapting to environmental and positional changes of the vehicle after having been driven from to various locations, within changing environments.

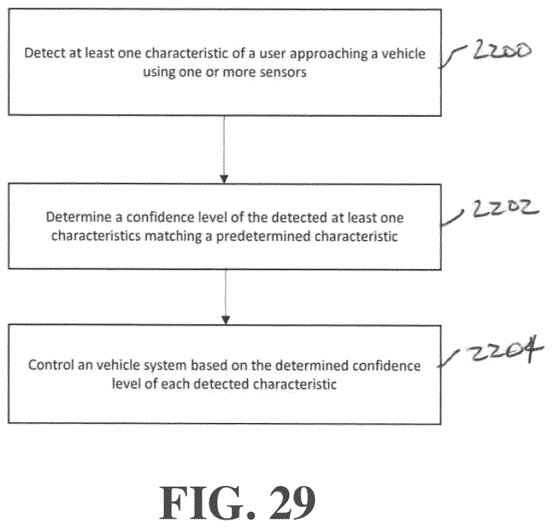

Now referring to FIG. 29, a method for controlling a system 100, 2000 of a motor vehicle 10 for facilitating access to the motor vehicle 10 by a user 109 of the motor vehicle 10 is also provided. More specifically, the method includes the step of 2200 detecting, using one or more sensors 122, at least one approach characteristic of the user 109. Next, the method includes the step of 2202 determining a confidence level of the at least one approach characteristic of the user 109 (i.e., intent of the user 109 to access the motor vehicle 10). The method also includes the step of 2204 controlling an access system 20, 110, 160 based on a determined confidence level of each of the at least one approach characteristic of the user 109. More generally, according to an aspect, the method includes the steps of determining an intent of the user 109 to access the motor vehicle 10 using the at least one approach characteristic determined and controlling an access system 20, 110, 160 based on the intent determined.

According to additional aspects, the method can further comprise determining a sensor performance level for the at least one sensors 122, wherein the overall confidence level is a function of the sensor performance level determined. More specifically, the at least one approach characteristic of the user 109 includes a plurality the approach characteristics of the user 109 and the step of determining the overall confidence level of the intent of the user 109 to access the motor vehicle 10 comprises determining individual confidence levels for each of the plurality of approach characteristics of the user 109 detected. In addition, the step of determining the intent of the user 109 to access the motor vehicle 10 using the at least one approach characteristic detected can be based on at least one of the individual confidence levels being above a predetermined confidence level. Furthermore, the step of determining the intent of the user 109 to access the motor vehicle 10 using the at least one approach characteristic detected can be based on a sum of individual confidence levels. The step of determining the intent of the user 109 to access the motor vehicle 10 using the at least one approach characteristic detected may also based on a weighted sum of the individual confidence levels. Additionally, the step of determining the intent of the user 109 to access the motor vehicle 10 using the at least one approach characteristic detected can be based on the overall confidence level being above a predetermined overall confidence level.

Again, according to another aspect, the step of controlling the access system 20, 110, 160 in response to the intent determined comprises controlling different functions of the access system 20, 110, 160 can be based on a determined level of intent of the user 109 to access the motor vehicle 10. In more detail, controlling different functions of the access system 20, 110, 160 based on the determined level of intent of the user 109 to access the motor vehicle 10 may comprise controlling increased functionality at each of a plurality of functional levels of the access system 20, 110, 160 as the determined level of intent is increased. In further detail, the plurality of functional levels of the access system 20, 110, 160 include a first functional level L1 with a maximum functionality of the access system 20, 110, 160 and a second functional level L2 with reduced amount of the functionality of the access system 20, 110, 160 compared to the first functional level L1 and a third functional level L3 with a further reduced functionality of the access system 20, 110, 160 compared to the second functional level L2.

According to an aspect, and as discussed above, the at least one approach characteristic of the user 109 is an approach vector of the user 109. In addition, the at least one approach characteristic of the user 109 includes a speed of approach of the user 109 towards the motor vehicle 10, a location of the user 109 while approaching the motor vehicle 10, a gaze of the user 109 approaching the motor vehicle 10. Also, determining the intent of the user 109 to access the motor vehicle 10 using the detected at least one approach characteristic may not be based on a detected gesture performed by the user 109.

As discussed, according to yet another aspect, controlling the access system 20, 110, 160 based on the determined intent can occur when the user 109 is detected to be within a predetermined access distance 2104 from the motor vehicle 10. More specifically, detecting, using the one or more sensors 122, at least one approach characteristic of the user 109 may be performed when the user 109 is detected to be within a predetermined sensing distance 2102 beyond the access distance from the motor vehicle 10. Similarly, detecting, using the one or more sensors 122, at least one approach characteristic of the user 109 can be performed in response to an authentication of the user 109 at a predetermined authentication distance 2100 beyond the predetermined sensing distance 2102 from the motor vehicle 10.

Again, controlling the access system 20, 110, 160 can be based on detecting a gesture adjacent the motor vehicle 10 after the intent of the user 109 to access the motor vehicle 10 is determined. Also, the step of detecting, using the one or more sensors 122, at least one approach characteristic of the user 109 may comprise using at least two different types of sensors 122.

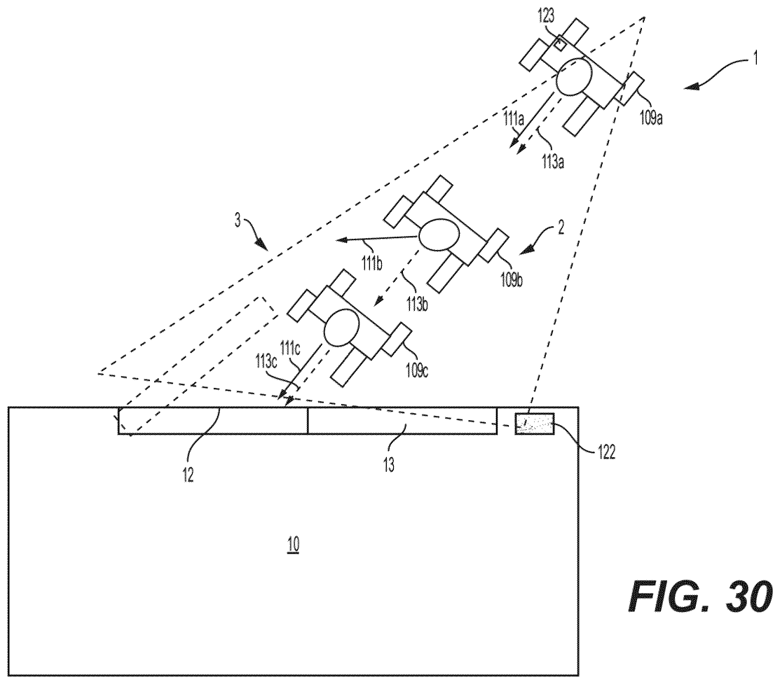

Now referring to FIGS. 30 to 34, there is shown illustrative operational examples of the systems and methods described herein above. FIG. 30 illustrates an approach of a user 109a towards the vehicle with having the intent to access the vehicle and have the door 12 opened, where the system is shown to infer the intent based on the actions and characteristics of the user 109 as the user approaches the vehicle 10. When the user is in a state represented by reference numeral 109a (i.e., position 1), the system may authenticate the user 109, detect, using one or more sensors 122, at least one approach characteristic of the user 109, which illustratively is the approach direction or vector of the user 109a towards the vehicle 10 or door 12 and whether the body of the user 109 is facing the vehicle 10. Using the one or more sensors 122, the system may also detect a distance to the door 12 within authentication zone, a direction of the user's gaze, and the user 109 body position facing the vehicle 10. Illustratively, both directions of the user's approach and gaze are directed towards the vehicle 10. The system may therefore infer with a high probability and confidence that the user in state shown as 109a has the intent to access the vehicle 10. Additionally, the system using one or more sensors 122 may determine something the user has 123, such as a FOB or other device, which may adjust the high probability and confidence. Using the using one or more sensors 122, a score or level of confidence that the user has the intent to access the vehicle 10 is determined. The system may power perform only an unlock. Such a score or confidence may change as shown when the user is in a state represented by reference numeral 109b (i.e., position 2), now being in closer proximity to the vehicle 10 having a same or similar approach vector 113b to approach vector 113a yet now having a direction gaze vector 111b which has changed compared to gaze vector 111a. The system may authenticate the user 109 and determine a distance to door 12 within an access zone. As a result the score or level of confidence that the user has the intent to access the vehicle 10 may be determined to be lowered, inferring the intent of the user to not access the vehicle 10, since for example the user's gaze has shifted elsewhere indicated that the user may subsequently alter his approach vector 113b to match his gaze 111b. As a result the score or confidence level is reduced and the system maintains the door status. Now the score or confidence may further again change as shown when the user is in a state represented by reference numeral 109c (i.e., position 3), now being in even closer proximity to the vehicle 10 and within an obstacle detection zone of the front door 12, and now still having a same or similar approach vector 113b to approach vector 113a yet now having a direction gaze vector 111c which has changed compared to gaze vector 111b to now being directed towards the vehicle 10. The score or confidence level representing the inferred intent of the user to access the vehicle is increased, and the system responds accordingly, for example by operating a power door presenter to present the door 12 to a user to grasp and open the door 12.

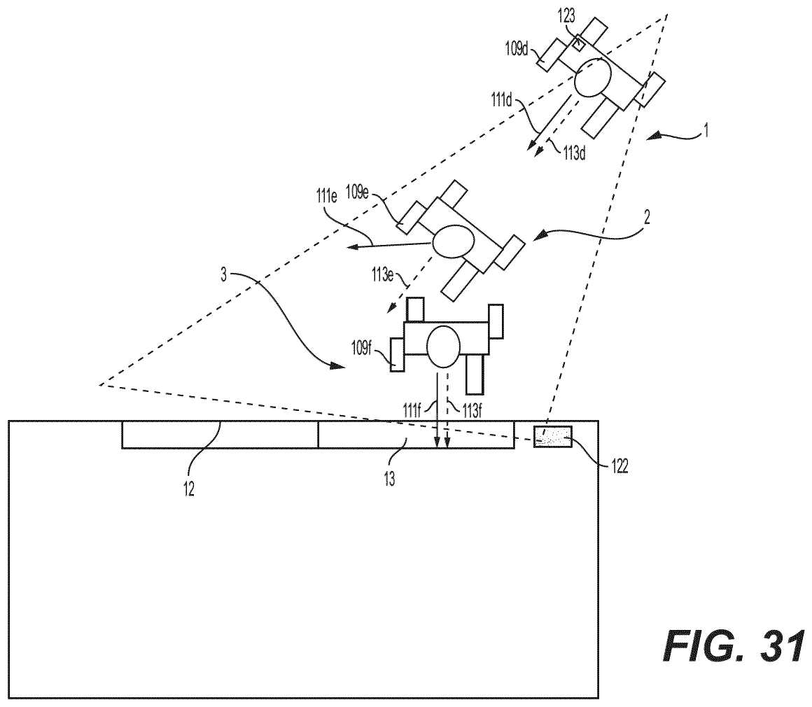

FIG. 31 illustrates another example approach of a user 109 towards the vehicle 10 with now having the intent to access the vehicle and have the rear door 13 opened, where the system is shown to infer the intent based on the actions and characteristics of the user 109 as the user approaches the vehicle 10. When the user is in a state represented by reference numeral 109d (i.e., position 1), the system may authenticate the user 109 and detect, using one or more sensors 122, at least one approach characteristic of the user 109, which illustratively is the approach direction or vector of the user 109d towards the vehicle 10 or door 13. Using the one or more sensors 122, the system may also detect a direction of the user's gaze shown as 111d. Illustratively, in state 109d both directions of the user's approach and gaze are directed towards the vehicle 10. The system may therefore initially infer with a high probability and confidence that the user in state shown as 109d at a distance from the vehicle 10 (e.g., within authentication range) has the intent to access the vehicle 10. Additionally, the system using one or more sensors 122 may determine something the user has 123, such as a FOB or other device, which may adjust the initially determined high probability and confidence score that is tracked as the user 109 approaches the vehicle 10. Using the using one or more sensors 122, a score or level of confidence that the user 109 has the intent to access the vehicle 10 is determined and the system may perform only an unlock function. Such a score or confidence may change as shown when the user is in a state represented by reference numeral 109e (i.e., position 2), now being authenticated and in closer proximity to the vehicle 10 and authenticated while not in the correct location and having a same or similar approach vector 113e to approach vector 113a yet now having a direction gaze vector 111e which has changed compared to gaze vector 111a. As a result the score or level of confidence that the user 109 has the intent to access the rear door 13 may be determined to be lowered, inferring the intent of the user to not access the vehicle 10 using the rear door 13, since for example the user's gaze has shifted elsewhere indicated that the user may subsequently alter his approach vector 113e to match his gaze 111e. As a result the score or confidence level is reduced. The system may be configured to generate a score or confidence level for each door. As a result a confidence level for the front door 12 may be rather increased after detecting the gaze of the user 111e directed towards the front door 12, so the system may maintain the door 12. Now the score or confidence may further again change as shown when the user 109 is in a state represented by reference numeral 109f (i.e., position 3), now being in even closer proximity to the vehicle 10 and within an obstacle detection zone of the rear door 13, and now still having a new determine approach vector 113f to approach vector 113e and now having a direction gaze vector 111f which has changed compared to gaze vector 111e to now being directed towards the rear door 13. The score or confidence level representing the inferred intent of the user to access the vehicle 10 using the rear door 13 is increased, and the system responds accordingly, for example by operating a power door presenter to present the rear door 13 to the user 109 to grasp and open the rear door 13 and/or unlocks and power opens the door 13.

Therefore, the system may be configured to determine a state of the user and determine a score based on the state of the user representative of the inferred intent of the user to access the vehicle, and control a vehicle access system using the score. The score may be altered based on sensed changes in user state, behavior, or things the user has. As discussed herein above, such access requirements may be different based on changes in the geo-positions of the vehicle, and based on changes in the surrounding environment of the vehicle, including changes in weather conditions or changes in people density (e.g. non-users) surrounding the vehicle, which may be reevaluated, determined or calculated by the system following a change in the state of the vehicle. For example, for, the access requirements when the vehicle is in one geolocation may be different when the vehicle has been moved to a different geolocation having been reassessed following the change in the position of the vehicle.

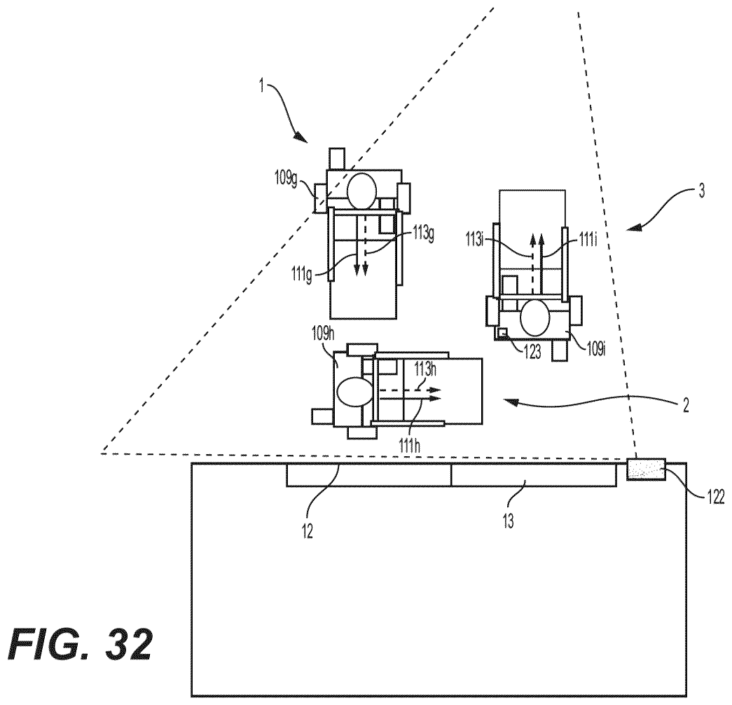

Now referring to FIG. 32, there is shown another example approach of a user 109 towards and/or about the vehicle 10 now not having the intent to access the vehicle 10 and have the rear door 13 opened, where the system is shown to infer the intent based on the actions and characteristics of the user 109 as the user approaches or moves around or about the vehicle 10. In FIG. 32, the user 109 is shown to be operating a lawn mower next to the vehicle 10, involving approaches towards the vehicle 10 without having an intent to access the vehicle 10. In user state 109g (i.e., position 1), the system may authenticate the user 109 and determine a score or confidence based on the detected characteristics of the user 109 as indicating medium intent to access the vehicle 10 and only perform an unlock, due to the approach vector 113g detected moving toward the front door 12 and the gaze vector 111g detected as directed toward the door 12 and body position of the user 109 facing the vehicle 10, while being within a authentication range of the vehicle 10. The system may then adjust the score or confidence level based on the detected characteristics of the user 109 being in the state 109h (i.e., position 2) where the direction such as approach direction 113h and gaze direction 111h are no longer oriented towards the vehicle 10 as indicating lowered intent to access the vehicle 10 while the proximity detected to the door 12 is increased. In user state 109i (i.e., position 3), the system may determine a score or confidence level based on the detected characteristics of the user the detected characteristics of the user 109 where the direction such as approach direction 113i and gaze direction 111i are away from the vehicle 10 and the system infers no intent to access the vehicle 10 by calculated a nil score or confidence. If, the system detects something the user has 123, such as activation of a FOB, when the user 109 is in state 109i, the system may increase the score or confidence level based to a high or certain probability that the user 109 has the intent to access the vehicle 10. Detection of something the user 109 has may override or greatly contribute to increasing the score or confidence level.

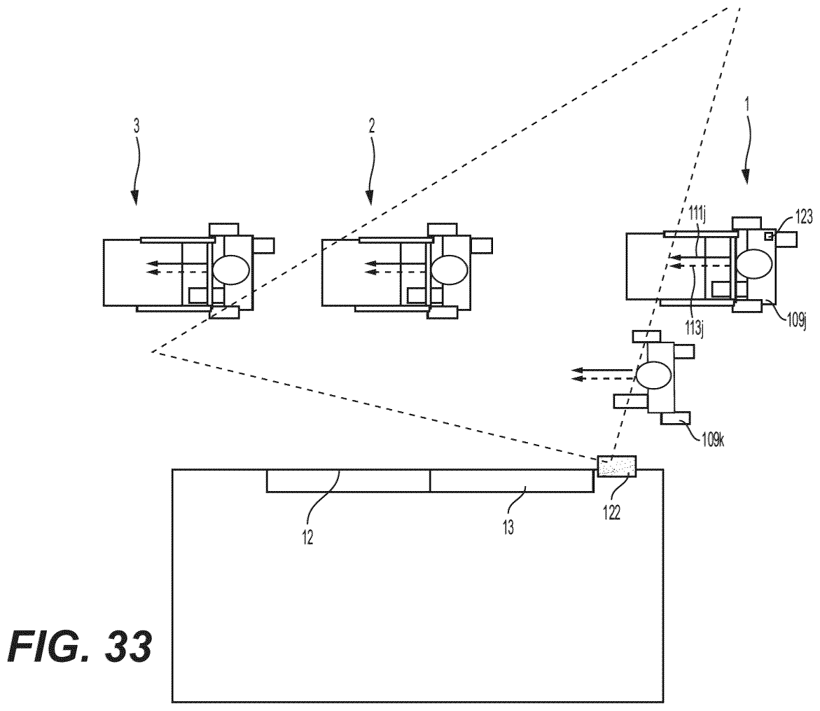

Now referring to FIG. 33, there is shown another example approach of a user 109 towards and/or about the vehicle 10, shown as 109j (positions 1-3) now not having the intent to access the vehicle 10 and have the rear door 13 opened, where the system is shown to change the score or confidence level as based on the actions and characteristics of the user 109 as the user 109 approaches or moves around or about the vehicle 10 and the system performs no further function. Note the system may be optionally configured to disregard the user 109, shown as user 109k which does not have a sensed something you have 123, such as a FOB. User 109 is illustrated in state 109k as representing a non-authorized passerby and will not be tracked by the system when adjusting the score or confidence level.

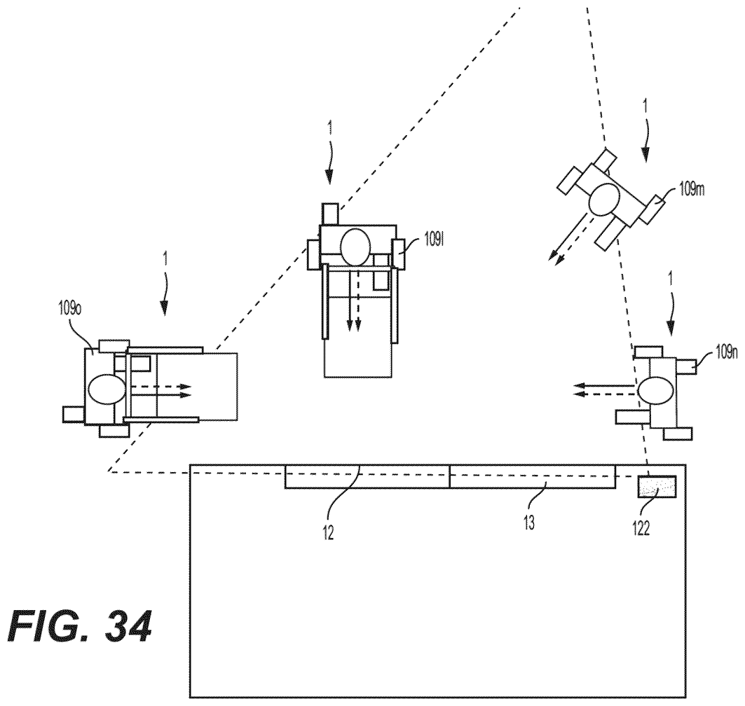

Now referring to FIG. 34, there is shown other example approaches of users 109l-o towards and/or about the vehicle 10 yet without a thing the use has, such as a FOB 123, where the system is shown to not change the score or confidence level as based on the actions and characteristics of the user 109 as the user 109 approaches or moves around or about the vehicle 10, but rather disregard the user 109 in states 109l-o. In another possible configuration, the system may track the users 109l-o and update the scores, yet not control access to the system without an authentication of the user 109 (e.g., using FOB 123). The system may grant access to the vehicle 10 if in lieu of something the user 109 has, the system detects something the user 109 knows, such as an activation gesture within a designated gesture detection zone.

FIG. 35 is a block diagram of a user detection system 2300 for a motor vehicle 10. Again, the motor vehicle 10 has at least one closure panel 12, 17, 19, 106 for facilitating access to the motor vehicle 10 by the user 109 of the motor vehicle 10. The user detection system 100, 2000, 2300 includes a hardware token 230, 231 associated with and carried by the user 109 to provide an authorization to access the motor vehicle 10. The user detection system 100, 2000, 2300 also includes at least two proximity sensors 122 configured to detect the hardware token 230, 231 in proximity to the motor vehicle 10. The user detection system 100, 2000, 2300 additionally includes the controller 26, 608, 612 connected to the at least two proximity sensors 122. The controller 26, 608, 612 is configured to determine a location of the user 109 relative to the motor vehicle 10 using the at least two proximity sensors 122. The controller 26, 608, 612 is also configured to grant or reject/deny access to the motor vehicle 10 via the at least one closure panel 12, 17, 19, 106 based on the authorization and the location of the user 109 relative to the motor vehicle 10. The at least two proximity sensors 122 and the controller 26, 608, 612 can comprise a vehicle intent detection system 2302. The actuator 22, latch 110, and at least one non-contact obstacle detection sensor 122a, b can comprise a vehicle-side power closure/latching system 2304. The vehicle-side power closure/latching system 2304 is used to unlock and open the closure panel 12, 17, 19, 106 upon the approach of the authorized user 109. A vehicle-side lighting system 2306 can be comprised of puddle lights 160 and welcome/dynamic carpet lighting lights 160. The vehicle-side lighting system 2306 is the means for providing visual feedback to the user 109 upon approach. For example, the turn signals 160 could blink on the mirrors and/or welcome lighting 160 or a dynamic curtain light 160 could be enabled. The user detection system 2300 also includes a plurality of vehicle-side radio frequency (RF) anchors/transceivers 2308 that can each include anchor transmit and receive antennas 2310 and an anchor processor 2312 (e.g., controller 26, 608, 612). The plurality of vehicle-side radio frequency (RF) anchors/transceivers 2308 (e.g., four of more per motor vehicle 10) are a means for data communication and localization and may use Ultra-wide Band (UWB), Bluetooth Low Energy (BLE) or other radio frequency technology to determine location (e.g., time of flight (ToF) and/or angle of arrival (AoA), etc. The hardware token 230, 231 can also include token transmit and receive antennas 2314, a token processor 2316, and a token accelerometer/gyro 2318. The hardware token 230, 231 could resemble a traditional keyless entry keyfob, or could be an enabled mobile device such as a cell phone, tablet, or other similar device. Lines indicated as 2315 may be CAN (Controller Area Network), LIN (Local Interconnect Network), Ethernet, GMSL (Gigabit Multimedia Serial Link), etc.). Lines indicated as 2317 may be CAN, LIN, Intelligent Smart Embedded LED (ISELED), general purpose input/output (GPIO), Ethernet, etc.). Lines indicated as 2319 may be CAN, LIN, pulse width modulated (PWM), GPIO, Ethernet, etc.). Lines indicated as 2321 may be CAN, LIN, Ethernet, etc.). Lines indicated as 2323 may be a radio frequency (RF) link (e.g., ultra-wideband (UWB), Bluetooth low energy (BLE), etc.).

So, the user 109 approaching the vehicle 10 would have the registered keyfob 230 or equivalent mobile device 231, such as a cellular phone or tablet. The mobile device or tablet 231 could be enabled with Ultra-wide Band (UWB), Bluetooth Low Energy (BLE), or similar technology to enable connectivity with the vehicle-side controller (e.g., controller 26, 608, 612). The controller 26, 608, 612 or body control module 27 (e.g., using its own processor or microcontroller 2301) can then control all of the various subsystems (e.g., access system 20, 110, 160) based on detection of the keyfob 230 or mobile device 231.

According to an aspect, the at least two proximity sensors 122 are disposed at at least two sensor positions on the motor vehicle 10. The controller 26, 608, 612 is configured to determine at least two distances between the user 109 and each of the at least two sensor positions. The controller 26, 608, 612 is also configured to compute the location of the user 109 relative to the motor vehicle 10 using a positioning algorithm relative to the at least two sensor positions. Thus, the distance between the anchors/transceivers (i.e., sensors 122) and the keyfob device 230 may be computed based on the time-of-flight (ToF) of the signals transmitted between the two devices 122, 230, for example. A two or three-dimensional positioning algorithm is then be used to compute the location of the user 109 relative to the vehicle 10.

The controller 26, 608, 612 is also configured to determine at least one of an approach trajectory and a non-identifying biometric information and a non-identifying biomechanical information using the at least two proximity sensors 122 (e.g., sensor/imager). The controller 26, 608, 612 is also configured to infer an intent of the user 109 to access the motor vehicle 10 based on the at least one of the approach trajectory and the non-identifying biometric information and the non-identifying biomechanical information. More specifically, according to an aspect, the controller 26, 608, 612 is configured to infer the intent of the user 109 to access the motor vehicle 10 based on the at least one of the approach trajectory corresponding to the user 109 approaching the motor vehicle 10 and correlated to an environment surrounding the motor vehicle 10. The the at least two proximity sensors 122 could be a camera or optical sensor or perhaps radar.

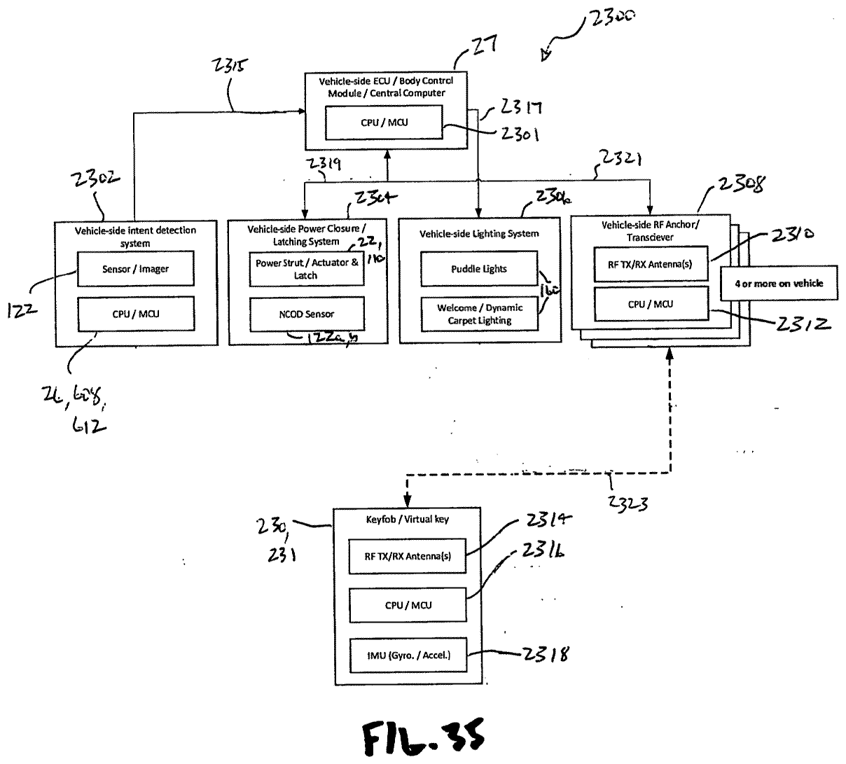

The positioning algorithm can be a two-dimensional calculation or algorithm could use triangulation. FIG. 36 shows an example positioning algorithm used by the user detection system 100, 2000, 2300. As shown, two virtual intersecting circles with radiuses can be formed by the respective ToF distance between the sensors 122 and the key fob 230. So, the at least two proximity sensors 122 can include a first sensor 122 disposed at a first sensor position (0,0) on the motor vehicle 10 and a second sensor 122 disposed at a second sensor position (0,I) on the motor vehicle 10. The first sensor position (0,0) is a sensor spacing distance 1 from the second sensor position (0,I). The controller 26, 608, 612 is configured to determine a first distance d1 between the user 109 and the first sensor position (0,0) and a second distance d2 between the user 109 and the second sensor position (0,I). The controller 26, 608, 612 is also configured to define a first circle with a first radius of the first distance d1 and a second circle with a second radius of the second distance d2. The first circle and the second circle intersecting at two intersection points (X, Y1) and (X, −Y1). In addition, the controller 26, 608, 612 is configured to determine the location of the user 109 relative to the motor vehicle 10 based on the two intersection points (X,Y1) and (X, −Y1).

So, the equations shown in FIG. 36 form the basis of the triangulation or positioning algorithm to place the user 109 along a 2-D plane relative to the vehicle 10. The time-of-flight distance d1, d2 from the user to two RF devices or sensors 122 are used to form the radiuses of the two circles. Then one of the two intersection points (X,Y1) and (X, −Y1) is determined to be the location of the user 109. Deciding between the two resulting intersection points (X,Y1) and (X, −Y1) can be done through an underlying assumption (e.g., user 109 will not be inside the vehicle 10) or through the use of a third RF device or sensor 122 to decide the correct data point. Similarly, a three-dimensional computation could use trilateration, which is a method for calculating position of the user 109 through the use three distance measurements. This process is similar to the intersecting circles method, however, would use three intersecting spheres to narrow down the position

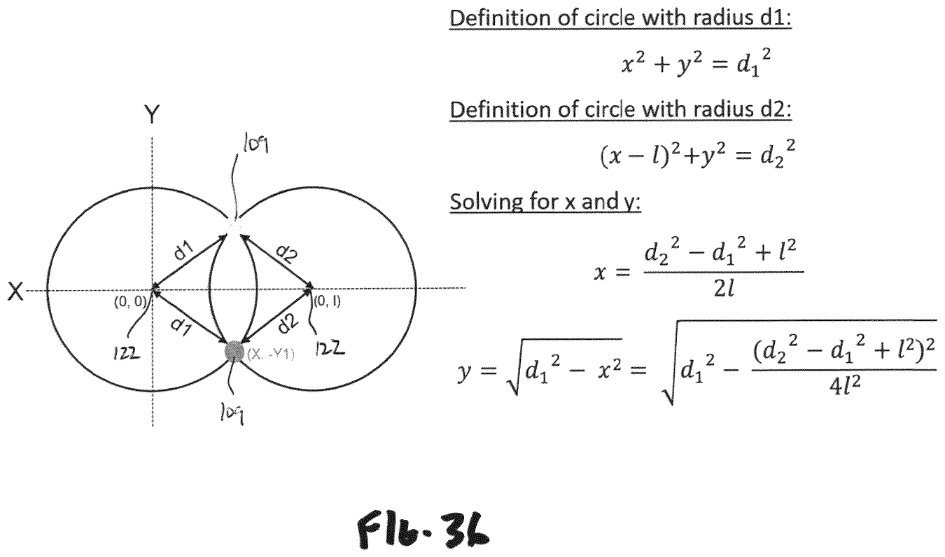

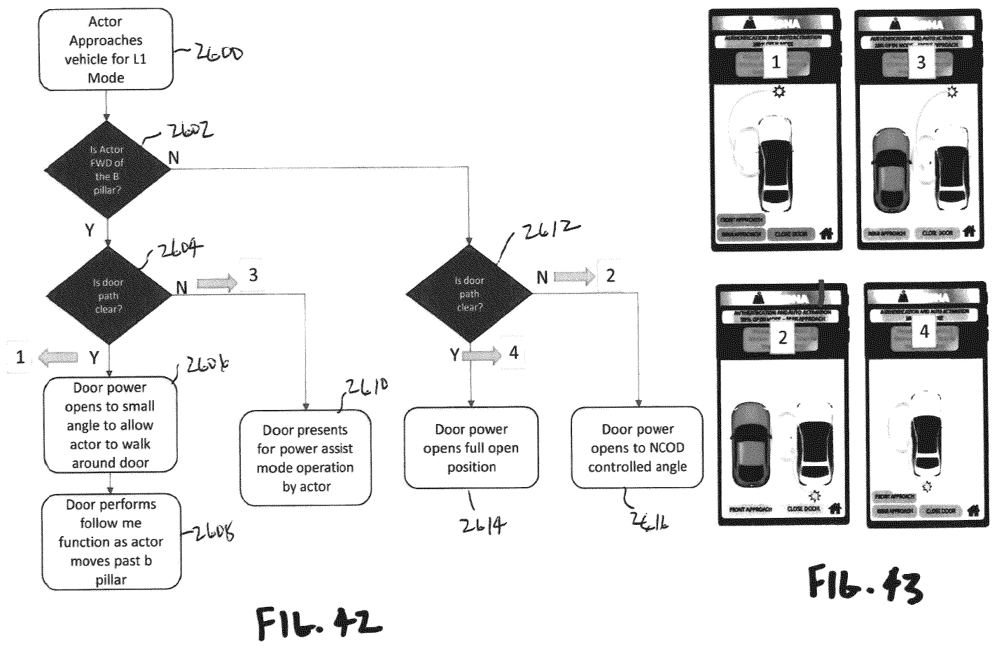

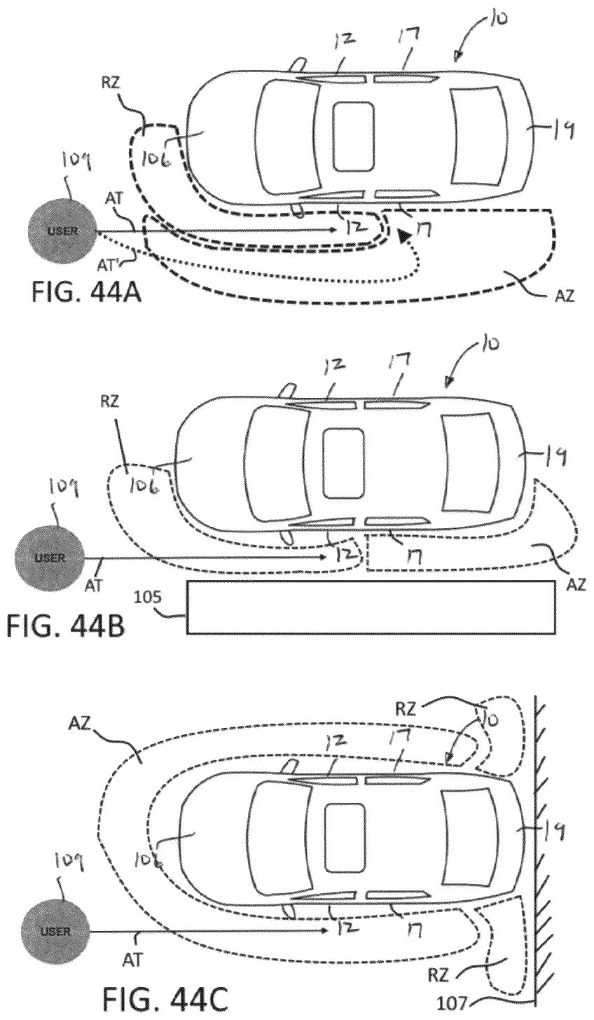

Therefore, according to an aspect, the controller 26, 608, 612 is further configured to poll an environment surrounding the motor vehicle 10 for the hardware token 230, 231 registered to the motor vehicle 10 using the at least two proximity sensors 122. The controller 26, 608, 612 is also configured to decide if the user 109 associated with the hardware token 230, 231 detected meets predetermined authorization requirements for accessing the motor vehicle 10 based on authorization signals received by the at least two proximity sensors 122 from the hardware token 230, 231. The controller 26, 608, 612 then wakes up the user detection system 100, 2000, 2300 and sends and receives location signals from the hardware token 230, 231 using the at least two proximity sensors 122 and determine the at least two distances between the user 109 and each of the at least two sensor positions. The controller 26, 608, 612 is additionally configured to execute the positioning algorithm and compute the location of the user 109 relative to the motor vehicle 10 using the positioning algorithm. In addition, the controller 26, 608, 612 is configured to determine at least one of the approach trajectory and the non-identifying biometric information and the non-identifying biomechanical information using the at least two proximity sensors 122. The controller 26, 608, 612 is also configured to analyze the at least one of the approach trajectory and the location of the user 109 and execute analysis of the non-identifying biometric information and the non-identifying biomechanical information. The controller 26, 608, 612 is further configured to verify that the user 109 is approaching the motor vehicle 10 within one of the plurality of valid access zones 2320, 2322, 2324, 2326 (FIG. 37) surrounding the motor vehicle 10. In one possible configuration the controller 26, 608, 612 may be adapted to change or vary the plurality of valid access zones 2320, 2322, 2324, 2326, such as by increasing or decreasing the area or volume next to the vehicle in which a detection of a user may be acted upon. Such adaptation of the controller 26, 608, 612 may be based upon the unique detected approach of the user to the vehicle which may vary for each different access approach, or may be a result of a detected obstacle using an obstacle detection system next to the vehicle, such as another parked car, or post as examples, may vary for each different access approach by the user, or may be based on a combination of the obstacles next to the vehicle and the approach of the user along a approach trajectory AT. For example and with reference to FIG. 44A, shown is a user detected by a proximity sensor detection system approaching the vehicle along an approach trajectory through a rejection zone (RZ), or invalid access zone, where access to the interior of the vehicle will be denied since the approach trajectory would have the closure panel swing into the path of approach of the user, thus avoiding having the user having to backtrack or side step the closure panel as it opens, or in some cases cause an obstacle detection system to activate and abruptly shut the door an and angle that doesn't allow access, or even cause the door to swing closed, thus adding inconvenience and confusion to a user. Shown also in FIG. 44A is a user detected by a proximity sensor detection system approaching the vehicle along another approach trajectory AT′ through an access zone (AZ), or valid access zone where access to the interior of the vehicle will be granted since the approach trajectory would not coincide with the swing into the path of approach of the user. Now referring to FIG. 44B, shown is an example of the access zones and rejection zones being varied based on a detection of another vehicle 105 detected being parked adjacent the driver's side of the vehicle Now, user detected by a proximity sensor detection system approaching the vehicle along an approach trajectory AT through a rejection zone (RZ) where access to the interior of the vehicle will be denied since the approach trajectory would have the closure panel swing into the path of approach and due to the adjacent vehicle 105 block the path of the user to a position beyond the front door. Thus, only once the user has entered into the access zone will the closure member be controlled to open In another possible configuration the controller 26, 608, 612 may be adapted to maintain the plurality of valid access zones 2320, 2322, 2324, 2326, fixed or invariable during operation such as by using a predetermined area or volume next to the vehicle in which a detection of a user may be acted upon. The controller can determined that the user has transitioned to the valid access zone from the invalid access zone and control the opening of the closure panel. For example, such invariable zones may remain the same regardless of any obstacle detected adjacent the vehicle, or any new location of the vehicle, or any specific approach of the user towards the vehicle. For example when one rejection zone (RZ) is controlled to be smaller, the other access zone (AZ) may be controlled to be larger, and vice-versa. Now referring to FIG. 44C, shown is an example of the access zones and rejection zones being varied based on a detection of wall 107 or other type of obstruction detected adjacent the liftgate 14 of the vehicle. Now, user detected by a proximity sensor detection system approaching the vehicle along an approach trajectory AT through a rejection zone (RZ) where access to the interior of the vehicle via the liftgate 14 will be denied since the approach trajectory would have the closure panel swing into possibly the obstruction. In another possible configuration the controller 26, 608, 612 may be adapted to maintain the plurality of valid access zones 2320, 2322, 2324, 2326, fixed or invariable during operation such as by using a predetermined area or volume next to the vehicle in which a detection of a user may be acted upon. For example and with reference to FIG. 37, zones 2336 always have a predetermined coverage of a volume or area about the vehicle, and for example about the corners of the vehicle, where no movement of the user therein may results in a determination to grant access. In other words, zones 2336 are referred to as dead zones. The controller 26, 608, 612 is then configured to grant or reject access to the motor vehicle 10 via the closure panel 12, 17, 19, 106 in response to the hardware token 230, 231 detected meeting the predetermined authorization requirements and the analysis of the at least one of the approach trajectory and the location of the user 109 the non-identifying biometric information and the non-identifying biomechanical information. Again, the hardware token 230, 231 can include at least one of a key fob 230 and a mobile phone 231 located with the user 109.

Thus, the access system 100, 2000, 2300 can poll at a specified rate using RF communication to scan the surroundings of the vehicle 10 for registered keyfobs 230 or other access devices 231. Once a registered device or hardware token 230, 231 is within the specified range for vehicle access, the access system 100, 2000, 2300 will check if the device 230, 231 is authorized to gain access to the vehicle 10.

FIG. 37 shows an example of a plurality of valid access zones 2320, 2322, 2324, 2326 defined around the vehicle 10. The controller 26, 608, 612 is configured to infer the intent of the user 109 to access the motor vehicle 10 based on the user 109 approaching the motor vehicle 10 in one of the plurality of valid access zones 2320, 2322, 2324, 2326. So, according to an aspect, the controller 26, 608, 612 is configured to read stored access zone information defining the plurality of valid access zones 2320, 2322, 2324, 2326. The controller 26, 608, 612 is also configured to compare the approach trajectory and location of the user 109 to the stored access zone information. The controller 26, 608, 612 is additionally configured to grant or reject access to the motor vehicle 10 via the closure panel 12, 17, 19, 106 based on the authorization and the comparison of the approach trajectory and location of the user 109 to the stored access zone information. As discussed, the controller 26, 608, 612 or body control module 27 would control all of the various subsystems (e.g., access system 20, 110, 160). For example, if the user 109 is approaching the vehicle 10 in one of the plurality of valid access zones 2320, 2322, 2324, 2326 as determined by the real-time localization system (RF & Intent systems) (e.g., controller 26, 608, 612), then the controller 26, 608, 612 could trigger lighting 160 and the relevant power closure system 20, 110. The system 100, 2000, 2300 could also potentially trigger power fold of the door mirrors according to the approach direction of the user 109 and the surrounding environment of the vehicle 10.

So, the determination of user intent based on position or approach trajectory can include the implementation of the predefined valid access zones where closure systems can be toggled from or not. Consequently, the user detection system 100, 2000, 2300 can include at least one proximity sensor 122 configured to sense the user 109 in one of a plurality of valid access zones 2320, 2322, 2324, 2326 defined around the motor vehicle 10. The user detection system 100, 2000, 2300 also includes at least one non-contact obstacle detection sensor 122a, b configured to detect at least one obstacle. The user detection system 100, 2000, 2300 additionally includes a controller 26, 608, 612 connected to the at least one proximity sensor 122 and the at least one non-contact obstacle detection sensor 122a, b and in communication with an access system 20, 110, 160 of the motor vehicle 10 associated with the at least one closure panel 12, 17, 19, 106. The controller 26, 608, 612 is configured to determine a location of the user 109 relative to the motor vehicle 10 and whether the user 109 is approaching the motor vehicle 10 within one of the plurality of valid access zones 2320, 2322, 2324, 2326 using the at least one proximity sensor 122. The controller 26, 608, 612 is also configured to detect the at least one obstacle in proximity to the motor vehicle 10 using the at least one non-contact obstacle detection sensor 122a, b and modify a functionality associated with the plurality of valid access zones 2320, 2322, 2324, 2326 to a modified access functionality based on detection of the at least one obstacle in proximity to the motor vehicle 10. In addition, the controller 26, 608, 612 is configured to control the access system 20, 110, 160 based on the location of the user 109 relative to the motor vehicle 10 and whether the user is within one of the plurality of valid access zones 2320, 2322, 2324, 2326 and the modified access functionality.

Still referring to FIG. 37, the at least one closure panel 12, 17, 19, 106 includes a plurality of closure panels 12, 17, 19, 106 each defining one of a plurality of closure boundaries 2328, 2330, 2332, 2334. So, according to an aspect, the plurality of valid access zones 2320, 2322, 2324, 2326 defined around the motor vehicle 10 extend and are defined at a plurality of predetermined angles from the plurality of closure boundaries 2328, 2330, 2332, 2334. In more detail, the at least one closure panel 12, 17, 19, 106 includes at least one door 12, 17 and a decklid 19 and a hood 106 and the plurality of valid access zones 2320, 2322, 2324, 2326 defined around the motor vehicle 10 include a valid hood access zone 2320 adjacent the hood 106 of the motor vehicle 10 and a valid front right access zone 2322 adjacent the at least one door 12, 17 on a right side of the motor vehicle 10 and a valid trunk access zone 2324 adjacent the decklid 19 of the motor vehicle 10 and a valid front left access zone 2326 adjacent the at least one door 12, 17 on a left side of the motor vehicle 10. The plurality of valid access zones 2320, 2322, 2324, 2326 are separated from one another by each of a plurality of invalid access zones 2336.

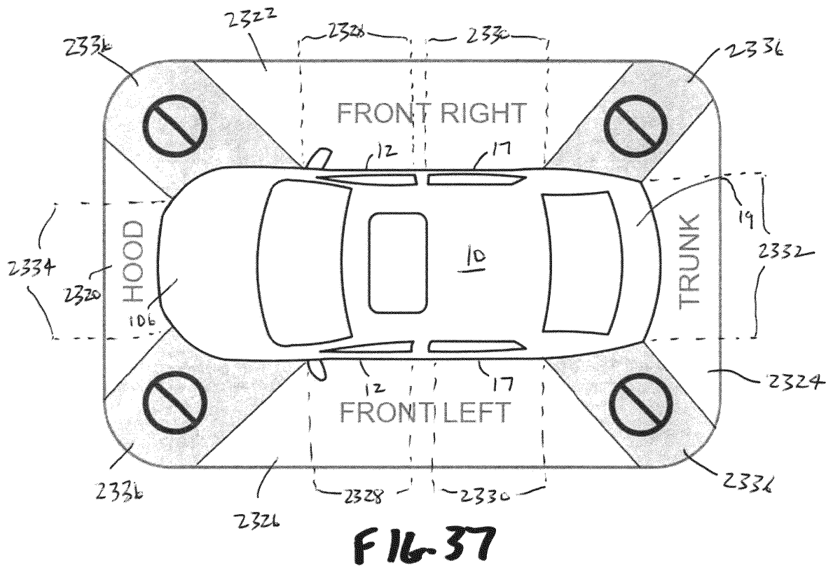

FIG. 38 shows an example of an approach path to the vehicle 10 due to an obstacle. So, a decision could be made by the controller 26, 608, 612 based on the direction that the user 109 is approaching the vehicle 10 and could be correlated to the surrounding environment of the vehicle 10. As shown, another vehicle is parked alongside the vehicle 10, meaning that the user 109 needs to approach the drivers door 12 from the front, or the rear as opposed to simply approaching from the side.

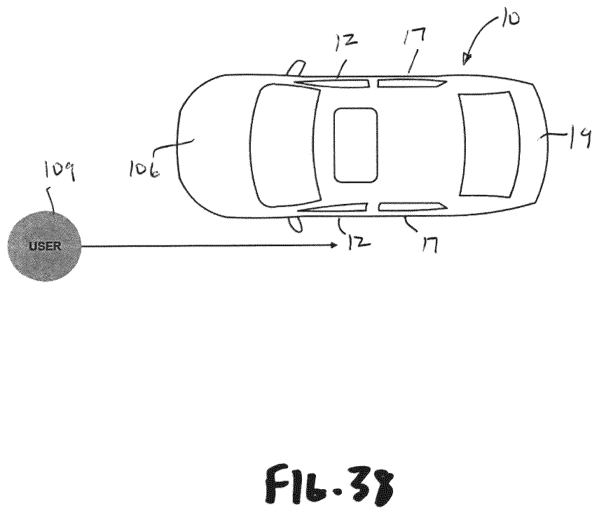

FIG. 39 illustrates a potential vehicle access truth table if the system uses UWB technology (e.g., ultra wideband sensor 122g) in conjunction with a camera or optical sensor 122d to determine user intent and trigger the access system 20, 110, 160. So, for example, the at least one proximity sensor 122 can include the optical sensor 122d configured to detect facial landmarks of a face of the user 109 corresponding to an intent of the user 109 to access the motor vehicle 10. The at least one proximity sensor 122 can also include the ultra wideband sensor 122g configured to sense the user 109 in one of the plurality of valid access zones 2320, 2322, 2324, 2326. Thus, the controller 26, 608, 612 is configured to determine whether the user 109 is within one of the plurality of valid access zones 2320, 2322, 2324, 2326 using the ultra wideband sensor 122g. The controller 26, 608, 612 is also configured to infer the intent of the user 109 based on the facial landmarks of the face of the user 109 and whether the user 109 is within one of the plurality of valid access zones 2320, 2322, 2324, 2326 and control the access system 20, 110, 160 accordingly.

As discussed above, the at least one closure panel 12, 17, 19, 106 includes door 12 and access system 20, 110, 160 can include a power closure member actuation system 20 configured to move the door 12. According to an aspect, the controller 26, 608, 612 is configured to detect the user 109 approaching the motor vehicle 10. The controller 26, 608, 612 is additionally configured to determine whether the user 109 is forward of a B-pillar 2338 (FIG. 1) of the motor vehicle 10. The controller 26, 608, 612 is also configured to determine whether a path of the door 12 is clear in response to determining the user 109 is forward of the B-pillar 2338 of the motor vehicle 10. Further, the controller 26, 608, 612 is configured to open door 12 to a small predetermined angle to allow the user 109 to walk around the door 12 using the power closure member actuation system 20 in response to determining the path of the door 12 is clear. In addition, the controller 26, 608, 612 is configured to present door 12 for a power assist mode operation by the user 109 in response to determining the path of the door 12 is not clear. The controller 26, 608, 612 is also configured to provide a follow me function of the door 12 as user 109 moves past the B-pillar 2338 of the motor vehicle 10 using the power closure member actuation system 20. The controller 26, 608, 612 determines whether the path of the door 12 is clear in response to determining the user 109 is not forward of the B-pillar 2338 of the motor vehicle 10. The controller 26, 608, 612 is then configured to open door 12 to a fully open position using the power closure member actuation system 20 in response to determining the path of the door 12 is clear. Additionally, the controller 26, 608, 612 is configured to open door 12 to an angle controlled by the at least one non-contact obstacle detection sensor 122a, b using the power closure member actuation system 20 in response to determining the path of the door 12 is not clear.

Also disclosed herein is a method of operating a user detection system 100, 2000, 2300 for a motor vehicle 10 having at least one closure panel 12, 17, 19, 106 for facilitating access to the motor vehicle 10 by a user 109 of the motor vehicle 10. The method includes the step of determining a location of the user 109 relative to the motor vehicle 10 using at least two proximity sensors 122 configured to detect the hardware token 230, 231 in proximity to the motor vehicle 10. The method continues with the step of granting or rejecting access to the motor vehicle 10 via the at least one closure panel 12, 17, 19, 106 based on the authorization provided by a hardware token 230, 231 associated with and carried by the user 109 and the location of the user 109 relative to the motor vehicle 10.

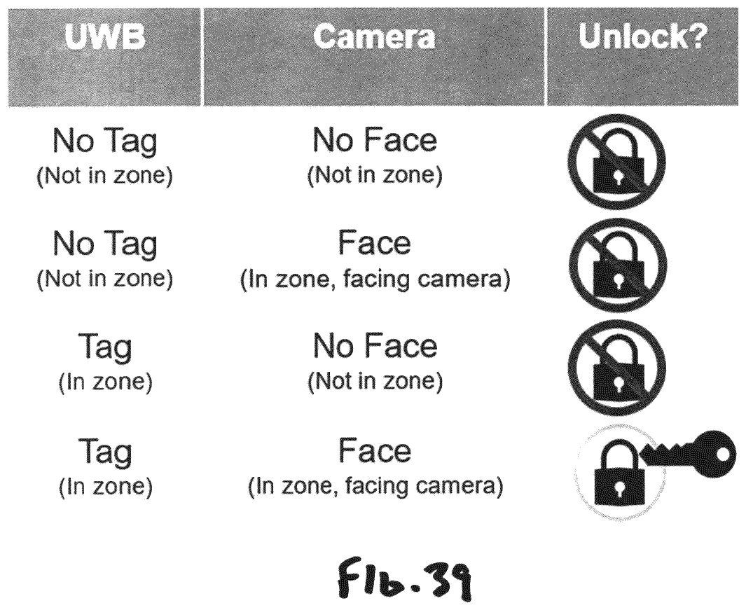

FIG. 40 illustrates steps of a method of operating a user detection system 100, 2000, 2300. As discussed, the at least two proximity sensors 122 are disposed at at least two sensor positions on the motor vehicle 10. So, the method includes the step of 2400 determining at least two distances between the user 109 and each of the at least two sensor positions. The method proceeds with the step of 2402 computing the location of the user 109 relative to the motor vehicle 10 using a positioning algorithm relative to the at least two sensor positions.

As discussed above, the at least two proximity sensors 122 can include a first sensor 122 disposed at a first sensor position (0,0) on the motor vehicle 10 and a second sensor 122 disposed at a second sensor position (0,I) on the motor vehicle 10. The first sensor position (0,0) is a sensor spacing distance 1 from the second sensor position (0,I). So, according to an aspect, the method further includes the step of 2404 determining a first distance d1 between the user 109 and the first sensor position (0,0) and a second distance d2 between the user 109 and the second sensor position (0,I). The method continues by 2406 defining a first circle with a first radius of the first distance d1 and a second circle with a second radius of the second distance d2. The first circle and the second circle intersecting at two intersection points (X,Y1) and (X, −Y1). The method additionally includes the step of 2408 determining the location of the user 109 relative to the motor vehicle 10 based on the two intersection points (X,Y1) and (X, −Y1).

Still referring to FIG. 40, the method can also include the step of 2410 determining at least one of an approach trajectory and a non-identifying biometric information and a non-identifying biomechanical information using the at least two proximity sensors 122. The method also includes the step of 2412 inferring an intent of the user 109 to access the motor vehicle 10 based on the at least one of the approach trajectory and the non-identifying biometric information and the non-identifying biomechanical information. In more detail, the step of 2412 inferring the intent of the user 109 to access the motor vehicle 10 based on the at least one of the approach trajectory and the non-identifying biometric information and the non-identifying biomechanical information includes 2414 inferring the intent of the user 109 to access the motor vehicle 10 based on the at least one of the approach trajectory corresponding to the user 109 approaching the motor vehicle 10 and correlated to an environment surrounding the motor vehicle 10.

Again, the plurality of valid access zones 2320, 2322, 2324, 2326 are defined around the motor vehicle 10. So, the step of 2412 inferring the intent of the user 109 to access the motor vehicle 10 based on the at least one of the approach trajectory and the non-identifying biometric information and the non-identifying biomechanical information can include the step of 2416 inferring the intent of the user 109 to access the motor vehicle 10 based on the user 109 approaching the motor vehicle 10 in one of the plurality of valid access zones 2320, 2322, 2324, 2326. The method further includes the step of 2418 reading stored access zone information defining the plurality of valid access zones 2320, 2322, 2324, 2326. The method continues with the step of 2420 comparing the approach trajectory and location of the user 109 to the stored access zone information. The method also includes the step of 2422 granting or rejecting access to the motor vehicle 10 via the closure panel 12, 17, 19, 106 based on the authorization and the comparison of the approach trajectory and location of the user 109 to the stored access zone information.

FIG. 41 illustrates steps of another method of operating the user detection system 100, 2000, 2300. According to an aspect, the method includes the step of 2500 polling an environment surrounding the motor vehicle 10 for the hardware token 230, 231 registered to the motor vehicle 10 using the at least two proximity sensors 122. The method proceeds with the step of 2502 deciding if the user 109 associated with the hardware token 230, 231 detected meets predetermined authorization requirements for accessing the motor vehicle 10 based on authorization signals received by the at least two proximity sensors 122 from the hardware token 230, 231. Next, 2504 waking up the user detection system 100, 2000, 2300 and sending and receiving location signals from the hardware token 230, 231 using the at least two proximity sensors 122 and determining the at least two distances between the user 109 and each of the at least two sensor positions. The method continues with the step of 2506 executing the positioning algorithm and compute the location of the user 109 relative to the motor vehicle 10 using the positioning algorithm. The next step of the method is 2508 determining at least one of the approach trajectory and the non-identifying biometric information and the non-identifying biomechanical information using the at least two proximity sensors 122. The method proceeds by 2510 analyzing the at least one of the approach trajectory and the location of the user 109 and executing analysis of the non-identifying biometric information and the non-identifying biomechanical information. The method continues by 2512 verifying that the user 109 is approaching the motor vehicle 10 within one of the plurality of valid access zones 2320, 2322, 2324, 2326 surrounding the motor vehicle 10. The method also includes the step of 2514 granting or rejecting access to the motor vehicle 10 via the closure panel 12, 17, 19, 106 in response to the hardware token 230, 231 detected meeting the predetermined authorization requirements and the analysis of the at least one of the approach trajectory and the location of the user 109 the non-identifying biometric information and the non-identifying biomechanical information. Again, the hardware token 230, 231 can include at least one of a key fob 230 and a mobile phone 231 located with the user 109.

According to an aspect, the method also includes the step of determining a location of the user 109 relative to the motor vehicle 10 and whether the user is approaching the motor vehicle 10 within one of the plurality of valid access zones 2320, 2322, 2324, 2326 using at least one proximity sensor 122 configured to sense the user 109 in one of a plurality of valid access zones 2320, 2322, 2324, 2326 defined around the motor vehicle 10. The method continues with the step of detecting at least one obstacle in proximity to the motor vehicle 10 using at least one non-contact obstacle detection sensor 122a, b configured to detect the at least one obstacle and modifying a functionality associated with the plurality of valid access zones 2320, 2322, 2324, 2326 to a modified access functionality based on detection of the at least one obstacle in proximity to the motor vehicle 10. The method also includes the step of controlling an access system 20, 110, 160 of the motor vehicle 10 associated with the at least one closure panel 12, 17, 19, 106 based on the location of the user 109 relative to the motor vehicle 10 and whether the user is within one of the plurality of valid access zones 2320, 2322, 2324, 2326 and the modified access functionality.

Referring back to FIGS. 37 and 38 and as discussed above, the at least one closure panel 12, 17, 19, 106 includes a plurality of closure panels 12, 17, 19, 106 each defining one of a plurality of closure boundaries 2328, 2330, 2332, 2334 and the plurality of valid access zones 2320, 2322, 2324, 2326 defined around the motor vehicle 10 extend and are defined at a plurality of predetermined angles from the plurality of closure boundaries 2328, 2330, 2332, 2334. Again, the at least one closure panel 12, 17, 19, 106 includes at least one door 12, 17 and a decklid 19 and a hood 106 and the plurality of valid access zones 2320, 2322, 2324, 2326 defined around the motor vehicle 10 include a valid hood access zone 2320 adjacent the hood 106 of the motor vehicle 10 and a valid front right access zone 2322 adjacent the at least one door 12, 17 on a right side of the motor vehicle 10 and a valid trunk access zone 2324 adjacent the decklid 19 of the motor vehicle 10 and a valid front left access zone 2326 adjacent the at least one door 12, 17 on a left side of the motor vehicle 10 and the plurality of valid access zones 2320, 2322, 2324, 2326 are separated from one another by each of a plurality of invalid access zones.

As discussed, the at least one proximity sensor 122 includes a optical sensor 122d configured to detect facial landmarks of a face of the user 109 corresponding to an intent of the user 109 to access the motor vehicle 10 and an ultra wideband sensor 122g configured to sense the user 109 in one of the plurality of valid access zones 2320, 2322, 2324, 2326. So, the method further includes the step of determining whether the user 109 is within one of the plurality of valid access zones 2320, 2322, 2324, 2326 using the ultra wideband sensor 122g. The method also includes the step of inferring the intent of the user 109 based on the facial landmarks of the face of the user 109 and whether the user 109 is within one of the plurality of valid access zones 2320, 2322, 2324, 2326 and control the access system 20, 110, 160 accordingly.

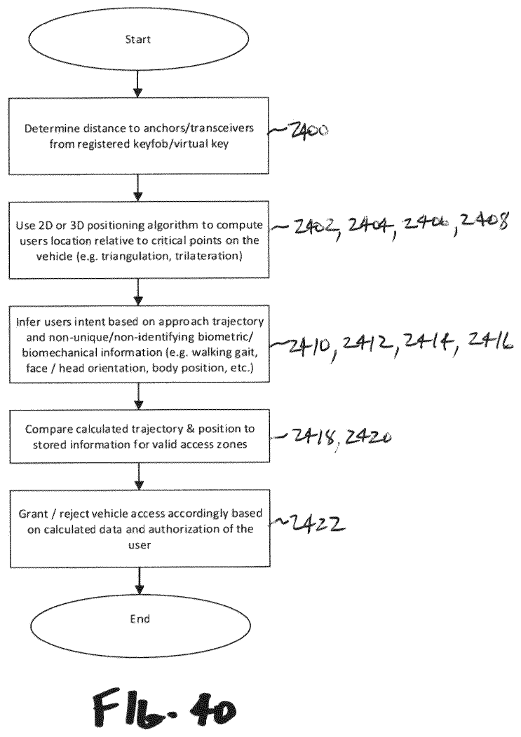

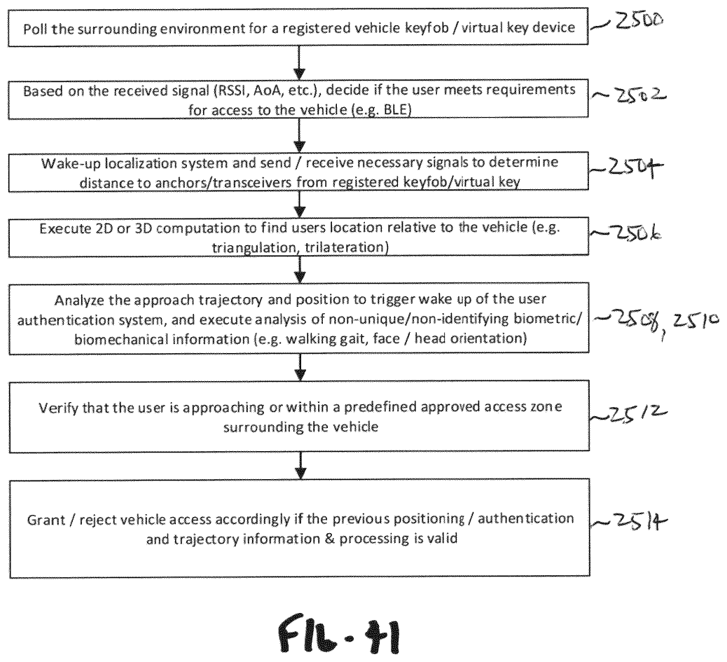

FIG. 42 illustrates steps of yet another method of operating a user detection system 100, 2000, 2300. FIG. 43 shows top views of the motor vehicle 10 pictorially illustrating specific scenarios corresponding to one or more steps of the method shown in FIG. 42. Again, the at least one closure panel 12, 17, 19, 106 includes door 12. Also, the access system 20, 110, 160 includes a power closure member actuation system 20 configured to move the door 12. So, the method further includes the step of 2600 detecting the user 109 approaching the motor vehicle 10. The method proceeds with the step of 2602 determining whether the user 109 is forward of a B-pillar 2338 (FIG. 1) of the motor vehicle 10. Next, 2604 determining whether a path of the door 12 is clear in response to determining the user 109 is forward of the B-pillar 2338 of the motor vehicle 10. The method continues with the step of 2606 opening door 12 to a small predetermined angle to allow the user 109 to walk around the door 12 using the power closure member actuation system 20 in response to determining the path of the door 12 is clear (also indicated as numeral 1 in a box corresponding to numeral 1 in FIG. 43). The method proceeds with the step of 2608 providing a follow me function of the door 12 as user 109 moves past the B-pillar 2338 of the motor vehicle 10 using the power closure member actuation system 20. The next step of the method is 2610 presenting door 12 for a power assist mode operation by the user 109 in response to determining the path of the door 12 is not clear (also indicated as numeral 3 in a box corresponding to numeral 3 in FIG. 43). The method continues by 2612 determining whether the path of the door 12 is clear in response to determining the user 109 is not forward of the B-pillar 2338 of the motor vehicle 10. The next step of the method is 2614 opening door 12 to a fully open position using the power closure member actuation system 20 in response to determining the path of the door 12 is clear (also indicated as numeral 4 in a box corresponding to numeral 4 in FIG. 43). The method also includes the step of 2616 opening door 12 to an angle controlled by the at least one non-contact obstacle detection sensor 122a, b using the power closure member actuation system 20 in response to determining the path of the door 12 is not clear (also indicated as numeral 2 in a box corresponding to numeral 2 in FIG. 43).

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A user detection system for a motor vehicle having at least one closure panel for facilitating access to the motor vehicle by a user of the motor vehicle, the user detection system comprising:
a proximity detection system configured to detect a user in proximity to the motor vehicle;
a controller connected to the proximity detection system and configured to:
determine a location of the user relative to the motor vehicle using the proximity detection system, and
grant access to the motor vehicle via the at least one closure panel based on the location of the user relative to the motor vehicle in a valid access zone and deny access to the motor vehicle via the at least one closure panel based on the location of the user relative to the motor vehicle in an invalid access zone.

2. The user detection system of claim 1, wherein the invalid access zones and the valid access zones are invariable.

3. The user detection system of claim 1, wherein the invalid access zones and the valid access zones are variable.

4. The user detection system of claim 3, wherein the invalid access zones and the valid access zones are variable based on at least one of the detected approach of the user towards the motor vehicle and a detected obstacle adjacent the vehicle.

5. The user detection system of claim 1, wherein the proximity detection system comprises:
a hardware token associated with and carried by the user to provide an authorization to access the motor vehicle; and
at least two proximity sensors configured to detect the hardware token in proximity to the motor vehicle;
wherein the controller is configured to grant access to the motor vehicle via the at least one closure panel based on the location of the hardware token relative to the motor vehicle in a valid access zone and deny access to the motor vehicle via the at least one closure panel based on the location of the hardware token relative to the motor vehicle in an invalid access zone.

6. The user detection system of claim 5, wherein the at least two proximity sensors are disposed at least two sensor positions on the motor vehicle and the controller is configured to:
determine at least two distances between the user and each of the at least two sensor positions; and
compute the location of the user relative to the motor vehicle using a positioning algorithm relative to the at least two sensor positions.

7. The user detection system of claim 6, wherein the at least two proximity sensors includes a first sensor disposed at a first sensor position on the motor vehicle and a second sensor disposed at a second sensor position on the motor vehicle, the first sensor position is a sensor spacing distance from the second sensor position and the controller is configured to:
determine a first distance between the user and the first sensor position and a second distance between the user and the second sensor position;
define a first circle with a first radius of the first distance and a second circle with a second radius of the second distance, the first circle and the second circle intersecting at two intersection points; and
determine the location of the user relative to the motor vehicle based on the two intersection points.

8. The user detection system of claim 6, wherein the controller is configured to:
determine at least one of an approach trajectory and a non-identifying biometric information and a non-identifying biomechanical information using the at least two proximity sensors; and
infer an intent of the user to access the motor vehicle based on the at least one of the approach trajectory and the non-identifying biometric information and the non-identifying biomechanical information.

9. The user detection system of claim 8, wherein the controller is configured to infer the intent of the user to access the motor vehicle based on the at least one of the approach trajectory corresponding to the user approaching the motor vehicle and correlated to an environment surrounding the motor vehicle.

10. The user detection system of claim 8, wherein a plurality of valid access zones are defined around the motor vehicle and the controller is configured to infer the intent of the user to access the motor vehicle based on the user approaching the motor vehicle in one of the plurality of valid access zones.

11. The user detection system of claim 8, wherein the controller is configured to:
read stored access zone information defining the plurality of valid access zones;
compare the approach trajectory and location of the user to the stored access zone information; and
grant or reject access to the motor vehicle via the closure panel based on the authorization and the comparison of the approach trajectory and location of the user to the stored access zone information.

12. The user detection system of claim 8, wherein the controller is configured to:
poll an environment surrounding the motor vehicle for the hardware token registered to the motor vehicle using the at least two proximity sensors;
decide if the user associated with the hardware token detected meets predetermined authorization requirements for accessing the motor vehicle based on authorization signals received by the at least two proximity sensors from the hardware token;
wake up the user detection system and send and receive location signals from the hardware token using the at least two proximity sensors and determine the at least two distances between the user and each of the at least two sensor positions;
execute the positioning algorithm and compute the location of the user relative to the motor vehicle using the positioning algorithm;
determine at least one of the approach trajectory and the non-identifying biometric information and the non-identifying biomechanical information using the at least two proximity sensors;
analyze the at least one of the approach trajectory and the location of the user and execute analysis of the non-identifying biometric information and the non-identifying biomechanical information;
verify that the user is approaching the motor vehicle within one of the plurality of valid access zones surrounding the motor vehicle; and
grant or reject access to the motor vehicle via the closure panel in response to the hardware token detected meeting the predetermined authorization requirements and the analysis of the at least one of the approach trajectory and the location of the user the non-identifying biometric information and the non-identifying biomechanical information.

13. A user detection system for a motor vehicle having at least one closure panel for facilitating access to the motor vehicle by a user of the motor vehicle, the user detection system comprising:
at least one proximity sensor configured to sense the user in one of a plurality of valid access zones defined around the motor vehicle;
at least one non-contact obstacle detection sensor configured to detect at least one obstacle; and
a controller connected to the at least one proximity sensor and the at least one non-contact obstacle detection sensor and in communication with an access system of the motor vehicle associated with the at least one closure panel and configured to:
determine a location of the user relative to the motor vehicle and whether the user is approaching the motor vehicle within one of the plurality of valid access zones using the at least one proximity sensor,
detect the at least one obstacle in proximity to the motor vehicle using the at least one non-contact obstacle detection sensor and modify a functionality associated with the plurality of valid access zones to a modified access functionality based on detection of the at least one obstacle in proximity to the motor vehicle, and
control the access system based on the location of the user relative to the motor vehicle and whether the user is within one of the plurality of valid access zones and the modified access functionality.

14. The user detection system of claim 13, wherein the at least one closure panel includes a plurality of closure panels each defining one of a plurality of closure boundaries and the plurality of valid access zones defined around the motor vehicle extend and are defined at a plurality of predetermined angles from the plurality of closure boundaries.

15. The user detection system of claim 13, wherein the at least one closure panel includes at least one door and a decklid and a hood and the plurality of valid access zones defined around the motor vehicle include a valid hood access zone adjacent the hood of the motor vehicle and a valid front right access zone adjacent the at least one door on a right side of the motor vehicle and a valid trunk access zone adjacent the decklid of the motor vehicle and a valid front left access zone adjacent the at least one door on a left side of the motor vehicle and the plurality of valid access zones are separated from one another by each of a plurality of invalid access zones.

16. The user detection system of claim 13, wherein the at least one proximity sensor includes an optical sensor configured to detect facial landmarks of a face of the user corresponding to an intent of the user to access the motor vehicle and an ultra wideband sensor configured to sense the user in one of the plurality of valid access zones, and the controller is configured to:
determine whether the user is within one of the plurality of valid access zones using the ultra wideband sensor, and
infer the intent of the user based on the facial landmarks of the face of the user and whether the user is within one of the plurality of valid access zones and control the access system accordingly.

17. A method of facilitating access to a motor vehicle by a user of the motor vehicle having at least one closure panel for an entry of the motor vehicle, the method comprising the steps of:
using at least one proximity sensor, sensing the user around the motor vehicle;
determining at least one of a location of the user relative to the motor vehicle and whether the user is approaching the motor vehicle;
determining if moving the closure panel to an opened position using an access system of the motor vehicle associated with the at least one closure panel, obstructs an approach of the user towards the entry; and
controlling the access system based on the location of the user relative to the motor vehicle to prevent the closure panel from obstructing the approach of the user towards the entry.

18. The method of claim 17, wherein the step of controlling the access system comprises not moving the closure panel.

19. The method of claim 17, wherein the step of controlling the access system comprises partially moving the closure panel.

20. The method of claim 17, further comprising determining if the location of the user is such that the approach of the user towards the entry is not obstructed by the closure panel in the opened position.
